(19) United States
(12) Patent Application Publication
(10) Pub. No.: US 2021/0374569 A1
(43) Pub. Date: Dec. 2, 2021

(54) Solution Automation & Interface Analysis Implementations

(71) Applicant: Joni Jezewski, Danville, CA (US)

(72) Inventor: Joni Jezewski, Danville, CA (US)

(21) Appl. No.: 17/301,942

(22) Filed: Apr. 20, 2021

Related U.S. Application Data
(63) Continuation of application No. 16/887,411, filed on May 29, 2020.
Application No. 16/887,411 is a continuation of application No. 17/016,403, filed on Sep. 10, 2020.

(30) Foreign Application Priority Data
Aug. 17, 2020 (US) PCT/US20/46705
Sep. 12, 2020 (US) PCT/US20/50591

(51) Int. Cl. G06N 5/04; G06F 40/247; G06F 40/30; G06F 40/166; G06N 20/00; G06Q 10/10; G06F 9/451

(52) U.S. Cl. CPC G06N 5/04; G06F 40/247; G06F 40/30; G06F 9/453; G06N 20/00; G06Q 10/10; G06F 40/166

(57) ABSTRACT

Solution automation & interface analysis components can be implemented in many ways, such as by specifying input/outputs & training a learning (generate, test & update) algorithm on the input/output data to generate a prediction function, to replace logic connecting input & outputs. Alternatively, specific logic implementations to connect input/output of sub-tasks to implement solution automation & interface analysis are included in the specification of this invention.

### FIELD

Embodiments of the disclosure relate to implementation methods of problem-solving automation & interface analysis.

### BACKGROUND OF THE INVENTION

Interface components like problem-solving automation workflow insight paths can be found/generated/derived/applied & implemented with various methods, such as by applying structures of problem/solution components/variables/structures, as the examples included specify.

These example implementations specify logic that can be used to implement the components referenced in U.S. patent application Ser. No. 16/887,411 & 17016403, which extend the implementation example sets given in those inventions.

### BRIEF SUMMARY OF THE INVENTION

One or more embodiments of the present disclosure may include a method that involves:
definition routes
problem/solution structures
solution filter structures (like metrics, tests, conditions) to filter solution sets, or specify/adapt/refine/test solutions
insight paths (including solution automation workflows, which are insight paths that connect problem/solution formats)
functions to generate solution automation workflow insight paths
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’). The object and advantages of the embodiments will be realized and achieved at least by the elements, features, and combinations particularly pointed out in the claims. It is to be understood that both the foregoing general description and the following detailed description are merely examples and explanatory and are not restrictive.

### BRIEF DESCRIPTION OF THE DRAWINGS

Example embodiments will be described & explained with additional specificity & detail through the use of the accompanying drawings in U.S. patent application Ser. No. 16/887,411 & 17016403, which contain diagrams of the relevant program components (like solution automation module 140) where example implementations contained in this specification can be applied.

### DETAILED DESCRIPTION OF THE INVENTION

As used herein, terms used in claims may include the definitions:
component: object, attribute, function, or structure comprising a piece of another object, attribute, function, or structure
structure (format): any information that can be visualized, like in a graph, thereby enabling some degree/type of definition, description, and/or verification/measurement
terms defined in patent application Ser. No. 16/887,411 & 17016403

As shown in FIG. 2 of patent application Ser. No. 16/887,411, the solution automation module 140 may include functions to find/derive/generate/apply definition routes, problem/solution formats, solution components like solution filters, insight paths, functions to generate insight paths, interface-query building logic, interface queries, and interface operations.

Method described in claims includes definition route examples.

### Vertex Structural Definition

vertex structures (like important vectors of causation or the important nodes in a network) can describe relevant variables of a structure
   the integrating structure organizing these structure formats (alternate, identifying) of a structure (vector) forms a complete description of a vertex, which can be indexed on a vertex vector space
   structures of these attributes can be used to define alternate definition routes of a vertex
      abstraction
         what vectors can be used to describe the vector generalization (like a vector in the vector type space)
      alternate
         what vectors can be an alternate for it (like an alternate route forming another vector)
         substitute
         what vectors can be a substitute for it, in what conditions
      generative
         what vectors generate it (input vectors+generative vectors)
      determining
         what vectors determine it (input vectors)
      contradicting
         what vectors oppose its direction
      neutralizing
         what vectors invalidate it
      balancing
         what vectors balance it (toward some equilibrium like a symmetry)
      limiting
         what vectors limit/bound/constrain it
      grouping/integrating
         how does it combine with other change types
         connecting
         how does it connect to other change types
         integrating
         how does it merge with other change types
      minimizing/averaging/maximizing
         how to get to zero
         how to get to average
         how to get to infinity
      causative
         what vectors cause it (consistently triggering inputs)
      optimizing
         what vectors optimize it (generate it or maximize it efficiently)
      core
         what vectors can be used to construct it using a structure (like a sequence or set)
      common
         what vectors are common to it & other vectors
      distorting
         what vectors distort it from some base vector (like a core or common or average vector)
      identifying
         what vectors can be used to identify it
         differentiating
         how to maximize difference
         approximating
         what vectors approximate it
         compressing
         what vectors efficiently compress it without losing info
         what info is lost with what compressions
         expanding
         what vectors efficiently expand it
      originating
         what vectors connect it or position it at which origin

### Structural Concept Definition Routes

nothing (lack) structures, as opposed to randomness (lack of differentiating info among possibilities)
opposite vs. lack (of common attributes/values, connections, similarities, spaces)
   opposite requiring a potential for extreme values to occur in a structural possibility where difference can develop
thinking definition as ‘applying structure to uncertainty’
reasonable (making sense) definition as ‘fitting an existing structure, like a pattern, without invalidating contradictions’

Relevance Structures
relevance: structures of meaning, having structural components like:
   truth
      structures of truth are useful structures for testing accuracy of a solution, to apply as solution filters
         predictive power (identifying output variables)
         explanatory power (identifying input cause)
         synchronization
         fit across systems
         alignment with other truths
         similarity
         adjacence to other truths (few distortions away from other truths) with aligning useful intent to explain distortion
         efficiency
         simplicity (few connections may be needed bc efficient structures are more stable)
         permanence
         consistency
         stability
         robustness
   adjacence
      similarity
      connection
      usefulness
         clarity (definition)
      interactivity
         probability of usage/interaction
         required resources
         usable resources
         efficient resources
   power (causative potential)
      core structures
      important (highly causative/generative/limiting) structures like vertexes & symmetries
   organization
      fit
      relative position
   intent alignment

Error Structures
apply definition of errors as structures of difference (what is not correct, meaning different from correct) to generate error types (structures of difference, like stacking variable permutations/distortions or generating new variables) and error patterns
create error types of ai using core combination generative function
   includes generating error type structures (combination of error types)
identify error type patterns (when differences accrue in this pattern, an error of some type is likely to occur)
create ai algorithm that is different in some variable from error type algorithms to guarantee an algorithm without those known error types
identify interface queries (or ai algorithms) that generate error types to use as filters to differentiate & guide design of new queries algorithms
example of error type in structure:
   any distortion can be used as an asset, & every position has an error inherent to its structure
   for example:
      ‘occupying the center position’ has:
         errors: having to do extra work to get to a position where it can handle less adjacent (outlier) problem types
         advantages: its work is distributed among many positions in every direction (many positions are adjacent) so if the problem is solvable with an adjacent position, and encountered problem types vary a lot, the center has an advantage
         ‘a position in between most common error types’ is another similar position that would have an advantage inherent to its structure, with the cost of having to do more work to get to a position where less adjacent error types are solvable, the less adjacent error types being more common than adjacent error types, but still less far than the average cost from other positions
      ‘having the most power’ has:
         errors: intent of ‘requiring dependency’, inability to delegate, over-responsibility (imbalance in blame allocation), boredom
         advantages: freedom in movement/change, ability to handle stressors, ability to make decisions that favor itself or its goals
   how to derive the error type from this distortion structure
      distortion structure:
         ‘too far in the direction of power centralization’
         associated objects (inputs/outputs) to components (power)
         with power centralization (power being at least an input to everything), other things are also centralized, like inputs/outputs/sub-processes of power (responsibility, decisions, dependency)
         ‘too central to reach outer positions quickly’
         variables (cost, function, priority) in structures (paths) to similar objects (positions)
         average cost to reach other positions may be lower than other positions, depending on density distribution or commonness of adjacent positions' associated error types, but cost to reach outer layers would be higher in the absence of efficient connecting functions
         this error structure can generate other error structures:
         bc it cant reach outer positions quickly:
         it cant identify/handle external stressors quickly without building functionality to offset that error, like an alarm system to get info to the center faster
         it cant quickly generate new outer positions like it can generate new adjacent positions
another method of generating error types
   example: a common problem type is a ‘mismatch/imbalance’ structure
      by applying the ‘mismatch’ structure to the core cost/benefit connecting function, you get an ‘inefficiency’ problem type, which can be defined as a mismatch/imbalance between the cost & benefit, favoring the cost side (which is the negative version out of the cost/benefit combinations, negativity being part of a definition route of a problem)
   apply core structures to problem components
      lack error type
         lack of resource
         lack of dependency
   apply definitions of error/problem components
      apply functions that can generate an error type according to its definition
         incorrect: apply changes to variables to generate incorrect values
         imbalance: apply distribution function to create imbalance of a resource
      apply core functions of error types to problem space objects or interface objects
         apply core change functions to:
         structure/position/format
         data
   apply definitions of optimal/solution components
      apply core structures to definitions of solution (functional/stable/optimal) states
         ‘requirements fulfilled’: change requirements to create error types like imbalances or lacks
         ‘functionality working’: break functionality
         ‘stable system’: overwhelm the system
         ‘optimal system’: solution metric unfulfilled
      generate error types by applying distortion functions to an origin optimal or stable (error-free) state(s) to generate deviations from optimal state
   error structures:
      over-structurization (specification) of an uncertainty/variable (assumption as fact, variable as constant)
      over-correction of an error
      over-prioritization
      over-reduction (over-simplification)
      over-variability (over-complication)
      misidentification of minimum info to solve
         distortions from expectations
         incomplete/damaged structure
   false equivalence structures
      ‘lack of functionality’ bc of root cause of ‘lack of memory’ or ‘lack of functionality to build functionality’ or ‘lack of intent for that functionality’
      the memory lack can look like a lack of ability, but its a false equivalence/similarity caused by a lack of an input resource, within a range of change potential where the memory lack & ability lack ranges overlap
   signals of the error type ‘low-dimensionality’:
      when motion approaches the solution metric (avoiding the error classification of not equaling the solution metric value), but never reaches it
         example:
         vertical dimension: robot fell onto another level vertically but is still moving toward destination as planned
         alternative agent/force dimension: robot fell onto truck and is moving toward planned destination temporarily
         time/speed dimension: robot encountered barrier preventing it from reaching its planned destination in under the planned time limit
         errors defined as differences between intended/actual structures
         errors are a difference type in a specific structure (between expected/actual values) so theyre useful as example core problem signals
         stacking errors may be a better way to frame problems than other interfaces
         the level of randomness captured by the error structure
         errors can function as limits as well as difference types building a problem structure
success vs. error structures
   when applying reductive insight paths to reduce solution space, identifying the set of unique isolatable component types (success, neutral, error, metric, function) on an interaction level is necessary to isolate subsets
   applying causal interface to problems (like ‘find a prediction function’) is required for some intents (like ‘reduce error’ or ‘handle change’)
   success cause structures (reasons, or why)
      finding the structure of similarity that explains ‘why’ an algorithm worked, such as a similarity in the form of an alignment in number of updates & degree of distortion allowed from a base function
   error cause structures
      error cause structures can be used to predict errors & used as filters to reduce solution space to similarity structures
         example: structures of difference like difference between core/required functions
         error type causes
         other error types (lack of rule enforcement)
         variable structures (irrelevantly similar variable structures, missing variables, variables that are constant, variable allocation/interaction)
         bias error type structures:
         variable combinations/connections that should be disassociated
error rules
when should errors be allowed to continue (when should motion be allowed in the direction of risk (risk of error types))
   when they dont impact system functionality, dont interact with other errors to form cascades/compounding errors, and provide useful signals of unhandled variance
   when uncertainties exist between alternatives
   apply flexible abstract/conditional/temporary error definitions to allow for beneficial errors & error-correcting errors
      example:
         ‘two wrongs make a right’
         when a robot instructed to go in a direction is forced off its trajectory by the first error, it has to make another error to get back on track, if an error is defined as ‘motion in any direction different from original planned direction’
         a solution is a definition of error types that is:
         abstract: any intentional motion that brings robot nearer to its goal is not an error
         conditional: any motion to correct an external error is not itself an error
         temporary: motion in a direction different from planned direction sequence is not an error in some temporary contexts
specific error structures, implemented with agency error structures (like stupidity, with components like bias)
   apply anti-error (anti-stupidity) structures to optimize neural network structures
      lack of learning functionality
         inability to remember (identify relevant info quickly when new info isnt necessary)
         inability to identify relevance structures (meaning, usefulness, direct causation)
         inability to optimize (identify a quicker route to an insight, like an insight path)
         inability to model structures (enough memory to store a different structure, ability to explore/change it like a visualization)
         inability to simulate difference structures (contradictions, paradoxes, lack of similarity)
         inability to direct thoughts (focus)
         inability to forget sub-optimal/inaccurate rules (bias)
         function to apply bias structures to a neural network structure
         thinking benefits from bias removal
         remove bias structures in neural networks to improve their thinking capacity
         example
         apply removal of ‘simplicity’ bias in a neural network structure
         simplicity (specifically over-simplification) definition on structural interface:
         lossy lower-dimensional representation
         low-cost representation with relatively reduced learning reward
         the simplicity bias shows up in a neural network structure in many possible positions
         for example, a pooling function, which has no reason to aggregate other than adjacence, which may not be an indicator of relevance
         find the structures that can build/derive/apply/store relevance and remove structures with artificial relevance
         general default params also tend to store simplicity where it's not needed
         apply removal of ‘similarity’ bias
         similarity bias structural definitions
         relatively adjacent in variable values according to a distance metric applicable & relevant to that variable
         the similarity bias shows up when adjacent structures are given relevance/meaning that they may not actually be capable of storing/building/deriving, like subsets of inputs or clustering thresholds
   bias structures:
      bias cycle:
         where specifically/partially false statements are falsely categorized as completely false, which triggers increase in distorted view of the group making the miscategorization error
         saying a specifically/partially false negative thing about a group often has a partially true sentiment backing it (most people in any group do negative behaviors enough to trigger negative sentiments), so even if the specific negative thing is wrong, the sentiment might not be
         the lack of acknowledgement of their own negative behaviors by the group saying the specifically/partially false statement also triggers the same response in the group making the miscategorization error (the group saying the specifically/partially false statement is doing a negative behavior, so the miscategorizing group has a negative sentiment about them, and often says specifically/partially false negative things about the group)
         conflating stereotype (‘false statement about a group’) with ‘a statement about a group that is more true of a higher ratio of that group than it is of other groups’
         stupidity manifests as similar structures (fulfillment of low expectations) across groups in response to low expectations, leading to feedback loop
   identify bias structures as output of operations on structures, or by missing structures that cause bias
      bias is a filter that leaves out relevant info
         ‘facts without connection to meaning’ is a biased priority (current state of truth) and a biased lack (ignoring potential truth & potential connections that change the meaning/position of facts)
         example: if you just focus on data set facts, you miss other facts (contradictions, counterexamples, alternative conditional variables/functions), as well as opportunities to derive other facts from the data set (given the favorability of the data set to influential entities, we can derive a guess that other facts might imply a different conclusion), and the connections between the data set facts & other facts (other facts imply a different cause than the data set facts) as well as the meaning of those connections (why this data set was selected)
   neural network with anti-bias structures built in (a complexity structure, a difference structure, etc) to correct error types from common biases

Info error structures
info asymmetry
   associated with an info loss (‘missing’ or ‘gap’ structure) in a particular direction between info types/formats/positions, rather than just an info imbalance or a mismatch
info imbalance
   a lack of equal distribution of info across positions
   related to the ‘incentive’ problem type, like incentives to maintain info imbalances to profit from lack of info leading to sub-optimal decisions

Opposite/difference vs. equivalent/similarity structures
similarities between difference & similarity
   distance metric
differences between difference & similarity
   amount of info that needs to be stored for a complete accurate description (‘what something is not’ may require more info to be stored compared to ‘what something is’)
the position of difference between difference & similarity may be on non-opposite positions on a circle depicting routes to get from difference to similarity
   this is bc a similarity is a degree of difference (low/zero difference) & so is a difference (higher degree of difference that can be measured or is observed as noticeably different compared to a similarity)
   the structure may be a circle or other loop bc if you stack enough differences, eventually you may generate the original object
the conversion of difference into similarity is based on the concept of a threshold, where a difference acquires enough similarities to similarity to cross the threshold or vice versa
the gray area in between the two concepts & surrounding the symmetry of the threshold also conflates the differences between the two concepts, making the difference not a simple ‘opposite’
example: spectrum structure
   handles different cases like ‘near low/high/average value’ (like between 0 & 1), which have differences in adjacent change types to produce relevant objects (like an integer)
      change types like ‘small change to produce an integer’, ‘doubling to produce an integer’, etc
   the isolated relevant difference structure (without additional info)
      the average value, which has multiple difference types in adjacent change types
   conditional relevant difference structures
      if the nearest integer triggers other change types, the value near that integer has a relevant difference structure
example: position structure
   similar positions will be near according to the distance metric, creating a radius of similarity, which results in emergent structures of a boundary, center & circle
   different positions can be represented as a structure lacking a circle/boundary/center
   the differences in similarity/difference structures have emergent effects & coordinate with different interface objects (like adjacent structures, change types, relevant objects, etc)
      a lack of an object can be used like other gap structures are used (as a filter, container or template)
      an object can be used as a component or other base object to use as an input
this is why differences are not just the ‘opposite of similarities’—it leaves out info like:
   similarities of varying relevance between similarity & difference (both use a distance metric)
   the reason why a difference is used vs. a similarity (like ‘filtering’ intents)
   emergent/adjacent/relevant structures of similarity & difference, embedded in different structures (position/spectrum)
   info about the structure of difference (difference paths/stacks/layers/trajectories), which may vary in ways that similarities do not
      this indicates the important point that similarities are insufficient to predict differences
   if similarities were equivalent to differences, you could use similarities to derive all info, reduce all uncertainty & randomness, and solve all problems—which is not guaranteed
   meaning ‘derive structures outside of the universe, using info from inside the universe’
similarities may have similarities to each other, more than similarities to differences
randomness has a similarity (in outcome probability), but is better than similarity as an input to generate difference structures like uncertainty

Uncertainty structures (like randomness collisions) & structures that produce certainty (combinations that stabilize into info)
randomness collisions generate structure
   structure being the stabilized interaction of info (staying constant long enough to attain structure)
   randomness being a lack of info (like a star or circle with equally likely directions of change)
      where influences are equal enough in power to leave no clear priority of direction favoring one over the other
   when an info lack interacts with an info lack, they may not generate another info lack, but a structure stable enough to organize them, depending on the angle/type of interaction and whether the info lacks are a similar or coordinating type

Method described in claims includes problem/solution format examples.

Solution of Optimized Network Structure
the optimized network can be structured as versions for different intents like:
   lowest-memory generator: the average network+distortion functions
   relevant generator: the network nearest to the most useful versions of it
   quick generator: the network with the components that can build other versions at lowest cost
   core generator: the network with core components to build all other components
   adjacent core generator: network with core components at an abstraction/interaction level where they are most adjacent (mid-level functions as opposed to granular functions or high-level agent-interaction functions or conceptual functions)
the optimized network (ark) has the interface components necessary to solve any problem, with no extra components
   it has one of each parameter of required components (like definitions, bias/randomness/error structures, interfaces, core/change functions, etc) which provide enough functionality to decompose & fit all discoverable info into a system of understanding
      for example, one example of each opposite end of a spectrum & the average in the center, or the average+distortion functions to generate the other possible values
can probably be adjacently derived from subatomic particle interactions, which implement the core objects of interfaces like cause & potential

Solution of Efficiencies Gained from Missing Components
some functions are generated more quickly without a component, bc of the needs that the lack generates, which focuses generative processes on building alternate functions to fill the gap
this can be used as a way to predict what tasks the optimized network with missing components would be relatively good at
missing component metadata
   how adjacently it can be learned/generated/invalidated/delegated/identified/borrowed
   how likely it is to be learned/generated/invalidated/delegated/identified/borrowed
   whether another missing component can be used instead
   whether the system missing that component should be changed instead
   whether a system having that component succeeds at the intent task (& fails at others currently fulfilled by the system missing that component)
example:
   not having a function incentivizes:
      identity: development of that function
      abstraction: development of generalization of that function, parameterizing that function intent
      alternate: development of a proxy or alternative or invalidating function, making the function itself unnecessary
      cause: development of structure/function/attribute that invalidates the original requirement metadata (priority, intent, dependency structures), not just invalidating the function
      alternate format: development of a structure/attribute that replaces the requirement for the function or allows the function to be generated as needed
      derivation: developing a function to learn/derive/identify/borrow/cooperate functionality from external info, to generate functionality as needed
      core: developing components capable of building all functions to generate functionality as needed
      subset: developing components of that function so the function & other functions can be generated as needed
      combination: development of a function capable of fulfilling that intent & other intents
      distribution: distributing functionality-generating methods to all nodes requiring functions
      organization: allocating gap requirements (uncertainties) to the gap in functionality (example: keep the gap so you can apply methods as a test to resolve the gap)

Method described in claims includes solution metric/filter/test examples.

General Solution Filters
example of a generating a general filter of meaning (as a solution is meaningful to a problem), by applying a definition of a component of relevance (usefulness)
   relevance
      usefulness
         applies solution structures (opposite to error structures) as structures of usefulness/relevance/meaning
         clarity (structure, definition)
         adjacence (reduction of cost to reach solution)
         connection (connecting problem & solution formats)
         reduction (reducing problem dimensions)
         fulfillment (filling abstract structure)
         optimization/organization (positioning components efficiently for a metric)
         similarity (resolve conflict)
         differentiation (identification)
         example
         the most useful functions (including patterns) will be:
         cross-interface patterns:
         patterns linking interface objects
         example of patterns linking all interfaces: error patterns
         patterns of interface object links
         change path patterns of randomness
         system patterns:
         patterns which unite other structures & form an interim structure in between meaning & problem-solving task intents
         core patterns & core interface components
         patterns which can build other components
         patterns in core interface components, like change/difference patterns

Solution Filters that Reduce the Problem Space
identify the worst error types, as assumption combinations having the lowest solution metric fulfillment if incorrect
   in the problem of ‘predict cat vs. dog’, the worst error types are:
      an object from one category having all the features used to differentiate between categories, but with variable values of the other category (cat having dog features)
      an object that is artificial identified as real (cat robot identified as a cat)
   to predict these error types, certain concepts need to be inferred
      the concept of ‘agency’ to design a machine that looks like an animal
      the structure of ‘false equivalence’ to design situations where features would look like a category but not actually be that
   identify all the feature ranges where it would be impossible to give high-accuracy answers (ai-generated cat image vs. real image)
   organize these filters in a useful sorting structure (network, tree) can reduce the computations required to solve for a prediction function, such as:
      placing the most-reductive solution filter first, if the info required for that filter is already available
      placing a filter after another filter that generates/identifies the info required for the second filter
      example of applying multiple filters to reduce solution space
         example of where a structural similarity could be used as an initial filter (in a dog vs. cat categorization algorithm)
         find similarity to type ‘dog’ and type ‘cat’
         in cases where similarities point to equivalent probabilities for each category, apply additional filtering structures than similarities
         apply base structures (random, core, common, etc)
         apply path structures (how many steps from a base to produce a clear answer)
         apply opposite structures (what is not a cat, what is not a dog)
         apply filtering structures (both/neither)—(what are cats/dogs both or neither of)
         apply structures of difference (what comes from a different origin/cause, like causes of evolving dog functions)
         apply state/time structures (could this become a dog or could it have been a dog previously according to definitive attributes/functions)
         apply variance structures (does this have variance from the cat base or following cat variance patterns)
         apply agency/group structures (what groups do cats belong to or which groups are they found with)
         apply system structures (what contexts normally go with ‘cat’)
         apply change/distortion structures (what distortions are often applied to cats or dogs)
         apply alternative path structures & network structure
         how many different paths could this data produce a dog category? (how to get to ‘dog’ answer using that particular data)
         apply boundary structures in network (cat type path set or path region, dog type path set or path region)
         re-apply similarity structures to boundaries (is this within the cat path region)
         apply pattern structures (does this match cat path patterns)

Solution Filters for Specific Problems
problem: create self-explaining AI
   self-explaining AI solution filter: able to identify metadata that aligns with its decision path, like:
      thresholds
      alternatives (selected & unselected based on thresholds)
      testing points (gather info about relative value to threshold)
      types/clusters
      examples
      statistics like average examples within a type
problem: create successful AI algorithm to identify probability of a particular solution's success
   solution metric filters:
      a successful AI algorithm would identify multiple solutions as probably successful, once variables of inequality are identified
         interface query structure (sequence)
         query: identify vertex variables (like ‘value’)
         query: identify input variables determining value:
         location
         what is a low-method to change location: public transportation
         what is a barrier to change location: visa, lack of info
         proximity to supply chains
         make an alternative supply chain between high-traffic suppliers/demands in other direction (across continent rather than across an ocean)
         relevant cost ratios (cost of going somewhere, finding job, selling something, finding info)
         query: apply function & intent interfaces
         find functions for intent ‘transfer resources’
         temporary markets (tasks that will probably be automated within n years, markets for goods people probably wont want/need in n years, or only need once, or only while a law is applied that will be changed soon, or products that need a connecting product until theyre all invalidated by another product being built)
         supply chains
         transportation
         delivery services
         query: find relevant interfaces
         laws
         code
         resource distribution
         location
         query: find solution methods
         connect existing resources
         apply multiple high-difference solutions, vary them to find subsets & versions that work
         query: find lowest-cost combination of solutions
         finding highest-value public transportation infrastructure to build (what routes would allow low-cost resource transfer for the most agents)
         finding temp markets (delivery/resource-sharing/education services)
         finding adjacent/existing law combinations to benefit the most low-income agents
         finding adjacent/existing bugs or code loopholes to benefit the most low-income agents
         query: organize info into a combination solution
         example of a combination solution, integrating multiple relevant interfaces, solutions, covering a high ratio of input variables to vertex variable
         ‘investing in delivery businesses near planned supply chain routes offering a high-traffic alternative route, and relocation or transportation infrastructure to enable lower-cost market participation with subsidized education for delivery workers to help them get better jobs and leave their jobs open for immigrants’

Solution Filters for Alternate Variable Sets
when testing different variable subsets, you can select a variable set split by structures like:
   vertex variables
   variables on interim interfaces where other variables aggregate (in bottlenecks or hubs)
   difference interactions
      difference type (homogeneous sets of difference types)
      differences in different types (heterogeneous sets of difference types)
      which difference type sets would identify the most errors or are the most different from other difference type sets
   which difference types are the biggest variance-reducers when combined
   which difference types have an attribute (common, relevance, similarity)

Solution Filters of a Truth-Filtering Algorithm (to Differentiate Real & Fake Content)
variable count/size (under-complexity, fragmentation, lack of smoothness/curvature)
wrong context for a pattern
over-repetition
over-similarity to previous info (lacking expected change structures, like change trajectory & types)
no matching reason/intent/priority for deviations from archetypes/patterns
over-correction when integrating a variable
variables identified in isolation
most clearly/measurably different variables identified
structure organizing variable structures (randomness injection points, enforcement gaps, info imbalances)
over-simplistic or erroneous automated sub-components
improbable level of randomness
   clear composition of core patterns
sources of randomness
   errors are evenly distributed among more complex adjacent sub-components not expected to change as much

Method described in claims includes insight path examples.

Example of Mathematized Insight Path
standardize variables to math interface structures & values
   apply type interface
      identify types
         standardize variables with types to differentiated clusters
         apply difference definitions (like variable subsets) until type separations are clear
         apply difference types until type separations are clear
   apply structural interface
      identify relative difference (difference from reference point, like origin node)
         apply adjacent structures (vector or spectrum or loop) to variables having the concept of ‘opposite’
   apply causal interface
      identify causal structures like direction
         apply structures with direction to variables having causation in their connections
   apply function interface
      identify variables with input/output relationships to form path between structures on meaning interface
   apply concept interface
      remove randomness
         compress variables with randomness injections to lower dimensional representations
   apply meaning interface (using a structural relevance definition)
      integrate variables in one structure to relate them
         identify any vertex variables as the preferred variables to standardize other variables to
         connect variables once formatted using adjacent/interim dimensions like topologies with variable subsets that can act as interfaces between connected formatted variables
         (can capture info from input & output variables in the connection)

Insight path of most useful structures for solution automation
these structures should be applied first in any generative process, including interface query design
   standards: filtering comparison methods
   definitions: problem/solution definitions
   optimizations/improvements: possible/probable changes for intents
   errors: difference
   metrics: intents
   similarity: adjacence, patterns
   relevance: connections
   organization: integration methods
these structures can be derived with system optimization principles, for attributes like:
   reusability: generative functions, definitions/constants/examples
   derivability: derivation functions & inputs (core functions, structure application functions, prediction functions, metric selection functions, test functions)
   independence: relevance calculation functions (to calculate meaning), system application functions (to derive context), organization functions (to build components using other interactive components)
   compartmentalization: core isolated unique components
importance: generative or vertex variables
efficiency: balance between variables & constants, derived/generated & stored functions based on usage & intent changes
   most useful standardizing structures to apply for generating & applying solution automation workflows (structures that connect problem/solution formats)
      example:
         combine useful structures (similarities, connections, & types) to generate a new solution automation workflow
         apply definitions of ‘error’ & ‘success’ to generate a new solution automation workflow:
         identify positions of known error types (abstract structures of difference from correct function output variable values) & avoid those positions
      problem/solution
         similar/different
         nothing/something, container/component, negative/positive, equal/opposite
         lack of structure/structure (mix, map, circuit, filter, value, position)
         balance/imbalance
         equivalence/comparison
         interaction/isolation
         dependence/independence
         relevance/irrelevance
         connection/disconnection
         type/subtype, type/other type
         substitute/alternative
         source/target
         constant/variable
         combined/standardized
         expanded/compressed
         attribute set/type
         function logic vs. input-output or intent-query map
         core/interactive
         root/meta
         unit/group
         set/reduction
         network/hub
         space/position
         possibilities/filter
         potential/adjacent
         requirement/change
         direction/force
         limit/efficiency
         intersection/separation
         contradiction/context
         conflict/alignment
         center/distribution
         uncertainty/certainty
         probability/outcome
         random/structured
         abstraction/info
         question/definition

Standard basic general insight paths (to apply structural interface to in order to make them specific to a context)
trial & error
reverse-engineering
break problem into sub-problems, find sub-solutions, merge sub-solutions into solution

Standard basic structural insight paths
generate adjacent structures & filter by relevant intents
find optimal structure (combination, path, direction, sequence) for a problem-solving intent (find predictive variable set, functions connecting input/output, priority direction, operation sequence) given metrics like adjacence (structural alignment, low-cost conversion potential) or available functionality/variation in that structure
find similarities (like fit, interactivity, coordination, direction, inputs/outputs, position) between available/adjacent/possible structures and connect problem/solution structures using these similarities (like function sequence with coordinating input/outputs)
find system context where source problem input & target solution output are adjacent with operations defined in that system
apply definitions of structural connection functions to connect problem & solution formats, using specific versions of sub-problems of structural connection functions like ‘equalize’, once a solution automation workflow like ‘break problem into sub-problems & merge sub-solutions’ is applied to the connection function definition, since specifying steps necessary to build the connecting function is the problem to solve
   equalize definition:
      apply conversions (like ‘change structures such as position or set’) to components of objects, until objects to equate are equal
   interface query applying solution automation workflow insight path ‘break problem into sub-problems & merge sub-solutions’ to ‘equalize’ definition
      intent: connect (equalize) objects
         intent: compare
         intent: standardize components to common core structures (such as base, combinations, & types)
         intent: connect once comparable (standardized)
         alternate intents:
         intent: find adjacent operations producing route from source to target value
         intent: filter adjacent operations by restrictive conditions like solution requirements (metrics)
         intent: substitute source with target value & reverse-engineer source value
         intent: filter components by equivalent components of source/target values
identify similar interface components (like concepts/structures) in other systems & solutions used to solve relevant problems in those systems, then convert & apply solutions from similar interface components to solve the problem in the original system

Insight Paths Optimizing for an Attribute Like Efficiency (Using Fewest Resources, with Relatively Good Accuracy)
identify interface object set necessary to get good approximate prediction results with existing algorithms & params
   find the abstraction level or definitions necessary to get an approximation of system or conceptual analysis with a standard data set
      definitions may include structures of relevance, like structures of similarity/difference
      the approximation may leave out other analysis logic like alternative/combination analysis (to identify sets of alternate prediction functions, or causal/functional/priority/missing/type structures in the data set)
      however it may find objects on an interface by including interface objects (include concept definition of agency/skill/decision in the titanic survival data set may identify concepts like ‘education’ as causative, given that a combination of agency/skill/decisions can be used to produce concept of ‘education’=‘an agent making a decision to acquire a skill’)
      similarly, including structural definitions of ‘relevance’ may improve prediction results with standard algorithms, allowing output structures of relevance like ‘semantic variable connections on the relevance level input to the algorithm’, such as an ‘explanation’
         ‘including’ meaning ‘standardizing to relevance structures, such as similarity/adjacence, inputs, interaction level, etc’
         first you'd apply standard analysis to get a set of probable dependency graphs, with paths like:
         gender=>lifeboat access=>survival rate
         then you'd apply standardization to relevance structures to the dependency graphs
         difference in functional position (gender roles)=>difference in function (skills)=>difference in usage (responsibility)=>difference in resource access=>‘survival’ intent inputs=>‘survival’ intent fulfillment
         the output would be an approximation of meaning, allowing explanations like ‘being female (variable value) increased probability (ratio of outcome among possible alternatives) of being prioritized (randomness structures like starting position as well as the concept of agency in filter structure) for access to survival tools (type of ‘lifeboat’) bc of less agency/responsibility/skills’

Solution Automation Workflow Insight Path Examples
solve problem by finding/generating/deriving solution structures like relevance (usefulness) with structures like efficiencies (usefulness through adjacence) in a problem system (like calculation efficiencies), then applying coordinating structures of those (like a sequence connected by coordinating inputs/outputs) as initial solution methods to refine with solution metric filters
solve problem by changing structures (like position) of interface objects, like functions & variables
use exclusively solution with known biases & error types so output can be corrected with logic from the associated solution type
identify similar systems & solutions used to solve the problem in those systems, then convert & apply solutions from similar system to original system
when generating solutions, identify:
   contexts/cases/conditions that can filter it out
   variables that can generate the most solutions
   filters that can filter the most solutions
      apply filters to solution space by solutions that are ruled out in fewest cases, best cases where solutions are less required or least probable cases
generate solutions from problem statement using interface objects
   core functions
   mixes/changes of previous or abstract solutions
   insight paths (break problem down, trial & error, etc)
   system structures
   core structures (opposite, equal, adjacent)
   function input/output chains
   vertex variables
   conceptual structures
apply solution format and reverse engineer solution
   apply solution filters that are adjacently derivable from problem/solution metadata (most-reducing filters that rule out the most solutions)
apply both the generate solutions method & solution format method and connect them in the middle
   rather than learning & fitting a function (applying new info to update standard equalized or randomized structure), apply structural insight paths that frequently produce accurate task completion (in general like producing problem/solution format connection sequence, specifically like producing prediction function)
find an example & generalize
   find core/unit objects, find example using those objects, & generalize
find an example & counterexample & connect them
execute a problem-reduction function/structure/question sequence
execute a solution-space reduction sequence before solving for remainder problem
run query to find interacting interface structures, then apply solutions for that specific problem space's interface network
identify vertex variables first & approximate
identify problem types & corresponding solution aggregation method for that set of types
identify alternative problems to solve (like whether to solve for organize, format, select, re-use, derive, discover, build, diversify, optimize, distort, or combine problems/solutions) & apply problem selection method, then solve
change problem into more solvable problem
   cause
      identify cause by applying network to causation, then select which cause to solve based on solvability with adjacent resources
   problem
      identify problem types of the problem & select which type to use known solutions for
apply structures
   cause
      vectorize problem system, filling in missing components with generative functions as needed
   function
      apply functions to move problem (origin) state position to solution (target) state position
      apply function input/output connections to connect problem input & solution output with function sequences
   system
      apply system structures like difference & incentive to generate & filter solutions for a priority like speed
      combine structures that avoid known error types & apply available functions to fit
      use solution for adjacent problem & apply available functions to fit
   intent
      apply map structure between problem-solution intents & function intents
   interface
      find interaction level where problem is trivial to solve
      apply structures of organization until problem is trivial to solve
   concept
      apply map structure between problem-solution concepts & sub-structure concepts
generate solution space first, then filter
   core
      apply core structures of solutions to generate probable solutions
      apply core functions to generate possible solutions & then apply filters to reduce solution space
apply filters first, then match with generatable solutions
   core
      apply components of solution filters to generate filters
   structure
      apply solution filters to reduce solution space
   system
      apply structures of difference (what is not the solution) to filter solution space, then match to what core functions can generate as adjacent/accessible solutions
apply solution structures (filters) & problem structures (errors, reductions) in parallel and connect in the middle

Method described in claims includes functions to generate solution automation workflow insight paths.

Insight paths that generate insight paths (like solution automation workflows)
identify patterns in structures allocating structure (constants) & lack of structure (variation) in interface queries to find new insight paths
   example:
      variation (like variables) allocated to structure & info interfaces, & constants (like definitions) allocated to the intent/concept interfaces
identify patterns in connecting structures as core components of interface queries (build interface queries with interface-connecting structures)
   examples:
      intent & function interfaces are connected as metadata & trigger structures, so the triggering structure can be followed by the triggered structure in interface queries
identify patterns of finding/selecting interaction levels for an interface query
   examples:
      core functions linking these interfaces
      structural versions of core functions linking these interface objects
      abstract network of an interface used for interface queries
      cross-interaction level conversion function applied before other interface query steps
example:
apply the insight path:
   ‘select commonly useful system objects for find problems’
to the problem:
   ‘find rules that fit a system such as a context’
after applying standard interface variables like:
   abstraction, intent, reusability, & complexity
to get system object filters from relevant problem interface object metadata like intents:
   problem intents: find, fit
which can be used as a filter to selected system objects
   ‘fit’ intent requires a structural similarity
with actual parsed query like:
   apply system object ‘structural similarity’ to find structural similarities in the problem system (‘find rules that fit a system such as a context’) after applying standard interface variables
      iterate through standard interface variables
         apply ‘simplicity’ to problem system
         output: ‘simple’ rules, ‘simple’ systems (and sub-type of system ‘simple’ context)
         iterate through system objects to find sources of efficiency in assembling a solution query
         apply ‘structural similarity’ to problem system
         output: structural similarity between ‘simple rules’ and ‘simple system’
      integrate output with original problem system to generate solution automation interface query for problem
         apply ‘simple’ rules (as a source of efficiency) in finding rules fitting a ‘simple’ system

Generate Solution Automation Workflows by Applying Functions to Components of Problems/Solutions (Like Variables, Workflows, Structures, Definitions)
generate solution automation workflows by applying solution automation workflows to other workflows
   solution automation workflow variables
      starting/ending position/format & format structure (like a sequence)
      interfaces applied, in what query structure
      allocation of uncertainty & variation
         problem to solve (generate solution filters, find workflow, break problem, solve original problem)
generate solution automation workflows using definition routes of problem/solution components like similarity/difference, relevance, truth, & cost
   the reason that applying structural definition routes works is that a problem/error contains structural similarities to its solution, like how a puzzle (a problem having structure ‘isolated pieces’) has solution structure ‘fitting pieces together’ or how a problem structure like ‘imbalance’ has solution structure ‘balance’
   so the point is to identify solution structure & find the interface where similarities & differences in problem/solution structure are clear and the problem/solution structures can be adjacently connected
   identify relevance structures (connections, truth, organization, optimization, usefulness) of high-similarity structures (extremes, opposites, reduction & isolation/distribution functions) in error structures (like an imbalance) of high-variation structures (power distribution, positive/negative charge, priority direction/extremity, causal direction)
   apply definitions of core structures of relevance structures to generate/filter/find/derive/connect solutions
      apply definition routes of cost as a core structure of efficiency, which is a core structure of optimization
         identify solution steps or solution(s) that optimize a definition of cost/reward
         definition route of cost on an interface like info would be an ‘info loss’, where a reward/benefit would be an ‘info gain’
         definition route of cost on structural interface would be ‘position change in direction away from target position’, where a reward would be a ‘position change in direction toward target position’
   combine problem structures & match with solution structures
      combine problem types
         a reduction/decomposition problem+a filling/aggregation problem=the solution automation workflow ‘break a problem into sub-problems, solve sub-problems, aggregate sub-solutions’
         combine structures & connect structure combinations by problem types
         the structure combination of ‘a sequence injected in a network’ is a structure matching a ‘route finding problem’, so apply solution structures that find a route in a network, such as filters using metrics or rules that can filter routes by which routes dont contradict rules
         the solution automation workflow is ‘find structures relevant to resolving problem structures like inequalities in other structures’ (inequalities like the difference between start/end positions)
         the workflow matches ‘sequence in a network’ with ‘route filtering structures’, connected by the problem format ‘find a route’
         combine structures & core functions
         the structure of the core function sequence(find, apply, build, filter)=matches solution automation workflows like ‘find components which, when this function is applied, can construct this structure, complying with these solution metric filters’
         combine components of solution automation workflows (functions, queries, interfaces, problems/solutions, structures) that have a valid input/output sequence
apply structures (combinations, sequences) of core problem-solving functions (equate, find, complete, filter, apply, derive components, generate, connect, change, reduce) as problem-solution connection functions
   examples:
      filter/reduce problem until its in the solution format
      equate problem format with solution format
      apply changes to problem until its the solution format
      generate solutions from problem format
      complete/fill structural components of solution format
   these functions dont have to match problem/solution formats (connect function can be applied to connect any structures, not just connection structures)
general insight paths permute variables of problems/solutions, like:
problem/solution abstraction level
system context (problem space, available resources)
adjacent interfaces & formats
info requirements (host system is known, some variable relationship rules are known, some definitions are known, variance gaps are known)
   problem/solution formats
      source problem input & target solution output structures to connect (like positions in a network)
         problem structures: structures of difference (between source & target structures), randomness (lack of structure/organization), inefficiency
         solution structures: structures of similarity (adjacence), usefulness (efficiency, relevance, organization), solution-reducing structures like filters
   format-connection functions/structures (solution automation workflow insight paths)
      cross-interface format-connection functions/structures
         format connection functions using definition routes of ‘connect’:
         ‘equalize’ (reduce difference)
         ‘organize’ (structure, fit)
         ‘cause’ (what causes solution)
         ‘use’ (what is useful, implying that if its useful, it will be used to connect something)
         ‘relate’ (what components are relevant to both problem & solution, like important causative vertex variables)
         ‘standardize’ (apply standardizing filter, for intents like ‘increase common similar components for comparison’)
         format connection function across interfaces:
         connection function between problem/solution formats, using objects with definable structures across interfaces like ‘standard’, ‘equal’, ‘error’, ‘difference’
      interface-specific format-connection functions/structures
         format-connection function on causal interface:
         find variables with structures of inevitability in the direction of caused variable

Generate Solution Automation Workflows by Applying Core Functions & Problem/Solution Components
apply core functions (find, derive, apply, build) & interface components to relate problem/solution components (problem space, origin/target, available info like definitions, structures, causes, concepts, sub-problems, adjacent formats, proxy problems/solutions, solution filters, problem/solution attributes like complexity)
connect (equate) problem/solution
   connect problem & solution formats
      general solution automation workflow: connect problem format to solution format
         core function version: apply ‘connect’ function to convert problem structures into solution structures
      connect problem & solution interface components
         general solution automation workflow: connect problem interface structures to solution interface structures
         core function version: apply ‘connect’ function to convert problem structures (like truth/stability) into solution structures (like uncertainty/potential)
disconnect (differentiate) problem/solution
   apply known errors as a filter to differentiate solution from
      general solution automation workflow: differentiate solution from known problems in problem space
         core function version: find filter separating solution from known problems in problem space
   apply problem structures as a filter to differentiate solution from
      general solution automation workflow: find structures of problem (like position of problem, or problem cause) & differentiate from those structures to find solution
         core function version: find opposite structures (like simplicity) of problem structures (like complexity) to find solutions
   apply problem structures of solution structures (solution errors) to differentiate solution from
      general solution automation workflow: find general causes of solution errors & differentiate solution from those causes
         core function version: find randomness, difference, & assumption structures (like a constant that should be a variable) and apply difference/opposite structures to those structures to build solution
   apply sub-optimal solution structures (sub-optimal solutions) to differentiate solution from
      general solution automation workflow: find sub-optimal solutions & differentiate solution from those solutions
         core function version: find structures of sub-optimality in existing solutions and apply difference/opposite structures to those structures to build solution
remove problem
   organize problem space so problem is removed
      general solution automation workflow: find structures in the problem space that would invalidate the problem (so problem doesnt need to be solved)
         core function version: find proxy solution structures (solving similar problems) or organization structures (like combination of position changes of problem space components) that would invalidate the problem
change problem into more solvable problem
   change problem into a structure of solved problems
      general solution automation workflow: find structures of solutions (solved problems) in or adjacent to the problem
         core function version: find components of or adjacent problems to the problem that can be substituted or equal solutions (solved problems)
   solve the abstracted problem (problem type)
      general solution automation workflow: abstract the problem & solve the abstract version (problem type), parameterizing the solution type to generate solutions
         core function version: apply abstraction interface to the problem & find solutions in that interface, then find parameters to specify solutions in specific problem spaces
   solve the problem of sub-optimal solution & error filters
      general solution automation workflow: build general solution & error filter structures & apply to problem with specific format
         core function version: build solution & error filter that can be applied to problem formatted as a network
   solve the problem of building solution with solution components
      general solution automation workflow: find structures of solutions & apply to problem to find solution
         core function version: find truth (stability, fit with other truths), probability (likely possibilities) & optimization structures (efficiency) & apply to problem structures to find solution
change solution into structures that can out-compete problems
   change solution into structures of optimization that can prevent problems
      general solution automation workflow: build solutions that have more structures of optimization than problems & problem sources (randomness structures) in the problem space
         core function version: build solutions that have more structures of optimization (efficiency/organization) than problems in the problem space

Generate Solution Automation Interface Query
iterate through interface objects (change type, problem type, assumptions, etc)
   find interface objects in a problem space
      filter by relevance structures (like interaction directness/causation, such as change hubs)
         apply problem structures related to relevant structures
         apply solution structures (like organization structures, like a sequence of tests/queries) to problem structures
specific logic automation example
   check for missing relevant info in info found with variables
      change to add earlier window to mtime param bc its out of error window
   find interaction type & change type in info metadata (filename, modification time relationship)
      any logs changed in later would include logs modified earlier bc of lack of incrementing/rollover, so mtime increase is unnecessary
   check assumptions for requirements
      mtime param unnecessary bc most logs would be modified in original mtime param
   check for relevant change-aggregation objects in structure (event objects in a sequence structure)
      significant date (upgrade, reboot) was within original mtime param which could be a factor in error so mtime param is necessary

Insight path to generate a solution insight path for a problem
apply solution structures like:
   balance between supply/demand
   maximizing benefit/cost ratio

to problem structures (metadata like available/missing info) to produce solution (insight path) variables:
cost of ignoring/focusing on info vs. benefit of actions like executing functions
cost of acquiring more info vs. benefits of applying quick best-case solutions
supply of available info vs. demand for info to solve the problem
then select/change variable structures (variable values & variable sets) to produce components of solutions (insight paths) for a problem:
   concept components: low-impact variables, high-variation variables, most causative problems, worst/best case context
   function components: filter (ignore/focus/assume), prioritize (set as primary intent), apply structure (like subset)
then apply structural interface to combine insight path components for a problem:
   ‘ignore low-impact variables to prioritize high-impact variables’
then filter by problem structure (intents, sub-intents) to re-integrate insight paths with problem:
   apply filters like:
      ‘is a direct cause of the problem ignoring local/contextual/worst-case/probability info?’
      ‘does a function applied to a component tend to cause problems in complex systems, and is this a complex system’

to produce reduction of possible solution insight paths like:
‘then ignore insight paths using those structures’
‘then apply further filters to check for a reason (possible benefit) to ignore that’
functional insight path (what to execute)::filter insight path (what to rule out or focus on)
   ‘breaking down problems into sub-problems’::ignore non-isolatable problem types & non-combinable solution types
   ‘identify worst case scenarios first and solving those in order’::ignore less harmful problems (local/output problems) to prioritize more harmful problems (causal problems, problem types)
   ‘identify vertex variables & standardize to them, using solutions that act exclusively on them’::ignore less impactful variables to address root causes
   ‘identify position of problem in causal network and apply solutions local to that context’ ignore systemic solutions to avoid side effects
   ‘find alternatives to solving a problem (delegation, solving abstract version)’::ignore specific solutions or move problem position
   ‘identify problem type & apply related known solutions’::assume problem type can be identified & covers enough of the problem & is abstract enough to apply related solutions with effective impact

Insight path to generate a solution automation workflow from a solution-problem connecting interface query (which functioned as an insight path)
once a solution is found, a solution automation workflow can be derived (and checked for uniqueness, compared to stored solution automation workflows or inputs/variables of generative functions of solution automation workflows) from the path taken from problem to solution (with general workflows like removing the problem, converting the problem into a solution with connecting functions, or generate the solution from solution components)
   this can be done with abstraction & connection to defined components
      example: if a solution like ‘find the difference in these two values, then apply this operation to get the output’ is found through a less optimal method like trial & error, abstract the method & standardize it to interface components so it can be integrated with the generative functions of solution automation workflows
         abstracted & standardized to interface components:
         find (change types and/or system structures like differences) in problem space, then find connecting structures of structured values & output structures

Method described in claims includes interface query-building logic examples.

Example of advantages of applying alternate interfaces, for selecting interfaces
the structure (position) of the component can be used to determine/differentiate its meaning
   ‘logy’ and ‘logi’ as prefix/suffix
      ‘-logy’ as a study of the prefix
      ‘logi-’ as a permutation of ‘logic’
the usage system context (sentences where they're used) can be used to determine intent
   ‘-logy’ used when:
      discussing science & interactions between fields/topics or changes in a field/topic
   ‘logi-’ used when:
      discussing reasoning/rationality
intent can be used to determine meaning
   use ‘-logy’ to describe a studying activity & topic
   use ‘logi-’ to reference logic, its interactions & permutations
structural interface (differences in position) can be replaced with:
   intent (reason to use within a system usage context)
   system interface (usage context to derive reason for usage), and fit to system (meaning)
applying different interface queries
   apply system context to derive intent
   apply structure (position) as an alternative to system context & intent
   apply intent to derive usage & system context

Generate other interfaces with interface components (connection, requirement, structure, abstraction, set, independence)
the interfaces defined as the following:
   intent: future direction with benefit to agency
   cause: preceding inevitability requirement in sequential structure
   function: structure of task structures (conditions, assignments, iterations) consistently connecting input & output
   logic: function to connect info using info structures (definitions, inevitability, pattern-matching, exclusive/inclusive conditions, requirements, assumptions)
   potential: structures like combinations not certainly excluded by requirements
   change: difference in an attribute value, according to a base (time, relative change, change type)
   abstraction: general pattern of a specific structure set
   pattern: a set of connecting functions, often in a sequence structure
   structure: connections & change of measurable change & difference types
   info: specific description of a structure
   math: description-connecting functions
system: structure of independence, often having boundary, function & other component structures, at a particular interaction level
have common components/variables, like:
   connections, time, structure, types
which can be used to create alternate interfaces, like:
   combine info, time, & types to create a new interface, combination interface, or interface structure (type state network, network of contexts/conditions/assumptions)

Multiple Queries for Low-Info Problem Statements
use parallel/perpendicular insight paths, for insight paths that add info that the other is less/more likely to retrieve
use the insight path combination that is likely to capture the most different/verifiable/incorrect info, which can be quickly tested for relevance or used to filter the solution space the most efficiently

Interface Query Variables
solution automation & interface analysis program implementation variables can be configuration options, and may include:
   generation starting point/source of truth
   voting influence in determining interface queries or system optimizations
   system optimization metrics
   constants, definitions, derived info, and functions
   default interfaces/definitions

Associating interface operations with intent
solve sub-problem ‘find combine structures after applying system interface’ for sub-intent ‘to find connecting structures in problem/solution system’
the intent of a sub-query should be defined in terms defined on that interaction level, to avoid gaps in connecting structures across sub-queries, so that further sub-queries of the sub-query can connect to the original triggering interaction level intent
example:
   when solving a problem with an insight path like ‘break problem into sub-problems’, the sub-queries to solve each sub-problem should be defined in terms used by the insight path & problem statement
   a sub-query to solve a sub-problem like ‘reduce & isolate dimensions of problem’ should be defined using the problem statement components & the insight path (‘break’ as the original function mapped to sub-functions ‘reduce’ and ‘isolate’), so when it comes time to integrate sub-solutions into a solution, the corresponding opposite function to ‘break(problem)’ can be applied to ‘integrate(solution)’, using a version of ‘integrate’ such as a specific version of ‘merge’ that connects to the version of sub-functions of ‘break’ used

Logic of selecting between insight path/query for a problem & generating a new one
logic dependencies
   problem metadata (complexity, adjacent formats)
   available info (whether metrics are capable of capturing relevant info)
   input data set metadata (whether variables are output metrics, variance-covering metrics, proxy variables, etc)
      different input/output relationships will imply different interface queries that will be useful
      beyond that, other (interface analysis-identified) methods to design an interface query for a problem type
apply interface analysis to interface query design (system including interface components, query components, metrics)—apply interfaces to the problem of designing an interface query
   examine what are the core functions, efficiencies, incentives, error types, etc of the interface query system, and check that they match what Ive identified
   check if you can skip some interfaces, like when you start with an input containing mixed-interface (concepts, functions, intents) or cross-interface structures (structures that apply/generalize to or connect interfaces), such as when you can identify common terms in input component definitions that can be used to frame all relevant objects
   once you standardize terms of component definitions, is there an interim sub-interface youve standardized components to, which can be used in place of a full interface query
   example:
      adjacent formats:
         problem is route optimization, problem format is network, solution format is network path, interface query should include function interface, bc function format is adjacent to finding a path on a network
      intent alignment:
         problem is over-complicated system, problem format is network, solution format is reduced-complexity system network, interface should include math & structure interfaces, to find & apply dimension-reducing functions (interfaces already contain functions that align with ‘reduction’ intent)
      required inputs:
         problem is ‘find a relationship between functions for calculation optimization intent’, solution format is ‘connecting function’, interface query should involve ‘connecting’ functions, which are a required input to solution format of a ‘function to connect functions that optimizes calculation efficiency’
      this can optimize for problem/solution metadata, as well as general problem-solving methods
         optimize for problem type: interface query for ‘missing info’ problem type should include the ‘similarity/difference’ sub-interface on the ‘structure’ to identify ‘opposite’ structures like ‘what is not there’
         optimize for solution format: interface query for a problem with solution format ‘prediction function’ should include either causal, potential, change, or function or structure.network interface, all of which can generate a structure connecting the in/dependent variables
         causal: organize variables with causal diagram having direction & check for predictive ability (identifying correlation, applying causal structures like moving/deactivating variables, using variable proxies or aggregate variables) to filter diagram for probable causation
         potential: identify potential alternatives (variable sets not in data set, randomness explanation) and filter if possible, possibly leaving original data set as last remaining solution
         change: identify variable change functions, and evaluate distorted data sets using those functions for alternate prediction functions, filtering by functions that are robustly predictive with more change conditions applied
         function: index variables as functions (functions using variable combinations/subsets) to check for input/output connectivity potential between in/dependent variables
         structure: organize the variables as a network to find relationships & if there is a relationship between in/dependent variables
      optimize for general problem-solving methods:
         example:
         ‘generate set of possible solutions & apply filters to reduce solution space’
         the interface query should have a format that is filterable once it reaches the filter step of the general solution method
         ‘break problem into sub-problems & combine & merge sub-solutions’
         the interface query should have a format that is combinable/mergeable once it reaches the combine/merge step of the general solution method

Problem-Solution Format Maps (Structural Components of Solution Automation Workflow Insight Paths)
based on where the problem is & what type it is, you can start with different methods:
   to invent something, start with structure-fitting or a conceptual query
   to understand a system, start with system derivation
   to predict an optimal function of variables in a system, & with system info & intents mapped in the system, start with vectorization of the problem space
   to find a path across a variance gap or use unused variance, & with system info, start with modeling gaps in the problem systems as solutions
   to find a quick approximation of system understanding & without time for system derivation, start with interface derivation
   with specific info about objects in the system, & without a few relationships, use queries on the object model
connecting problem & solution formats has a set of workflows based on structure & adjacent solution automation workflows that can direct the interface query design by the requirements of the steps in those workflows
   examples:
      connecting a problem of ‘too much structure’ and solution of ‘reduced structure’ has a workflow involving steps like ‘reduce variables’, with requirements like ‘variables’, so the function or change interface can be applied to identify variables before executing that step in the workflow
      connecting a problem & solution with a particular solution automation workflow also has input requirements, like ‘break a problem into sub-problems’ workflow, which requires that structure of variables (error/differences) are identified (to identify sub-problems), so applying the structural, function, or system interface is necessary to identify those structures which act as sub-problems
   interaction structures allow interactions to develop but are different from interfaces/standards that specifically enable communication/comparison interaction types, despite interaction structures acting as a connecting structure which has structural similarities to communication, communication being the exchange of info that is interpretable & actionable to source/target
   find equidistant point to info to start parallel interface queries from
connecting problems & solutions with error types (opposite of connecting with solution types)
   associate error types (with interface metadata like intents, causes, structures) with problem & solution types, to identify connections like:
   what errors can be present in a solution that can still be considered successful
   what errors are considered a problem or equal to the input problem when combined in a structure
   iterate through possible interface definitions of problem/solution
      problem::solution
         general connecting function:
         sub-optimal state::more optimal state
         specific problem/error type connecting functions:
         state with errors::state with fewer errors
         state with unused resources::state with fewer unused resources (unnecessary dimensions)
         state with no possibility for change: state with possibility for change (randomness injection points, variance sources, dependencies)
         distorted state (specific intent)::undistorted state (center)
         state where organization is a dependency source (too big to fail)::state where organization is an efficiency source (solution provider)
         specific solution for specific parameters/values::abstract parameterized solution
         mismatched format::matching format
         misaligned intents::aligned intents
         info dependency::info generating function dependency
         unknown cause::set of possible causes of varying directness
         state with inability to self-correct::state with self-correcting function
         state with inability to interact::state with core functions to build interaction function & function to change interaction level
         lack of chaos::variance injection, variance source
         when a system has no errors, that means its either not finding new variation (unlikely if capable of doing so), not capable of finding variation, or is not learning
         inject errors to try to produce variation
         apply function to build functionality to find/generate variation
         apply errors/changes to learning functions to produce new learning functions
         structure::different structure
         direction::position
         goals (result, impact, resource)::flexibility (increase in function, increase in power)
         missing structures (sub-type of opposite structures, sub-type of difference structures)
         lack of structure::unnecessary structure
         sub-optimal solution::improved solution
         solution set::optimal solution
         decision options::executed decision
         lack of decision::decision options
         lack of power::locally concentrated power
         too much (concentrated, high density, unnecessary, unmanageable) power::globally distributed power
         apply error & problem types to generate other possible definitions of a problem & solution, allowing functions connecting them to be built/stored specifically for those types
         apply system optimizations to all interface components
         example:
         apply ‘have multiple variance sources’ to ‘variance sources’ for intent ‘distribute power’ of input variance across sources
         filter optimizations by contradicting intents that are identifiable as useful for functions connecting problem/solution structures
         apply error types to interface component design/optimization
         applying error type solutions to functions
         ‘avoiding dependencies’
         ‘avoiding traps leading to dead-end static states where variance injections cant change the system’
         to avoid the associated error types:
         ‘missing dependencies’, ‘cost of generating dependencies’
         ‘lack of flexibility’, ‘lack of potential’, ‘lack of functionality’
generate possible (full set) & probable (adjacent or useful set) formats to use to connect problem & solution
   identify relevant structures to the object an interface is based on, given its definition
      examples:
         cause & intent have a relevant structure of ‘direction’
         cause has a relevant structure of ‘inevitability’ & ‘uniqueness’
         intent has a relevant structure of ‘usefulness’ with structures of ‘clarity’ and ‘efficiency’
         system has a relevant structure of ‘network with boundary & circuits (as commonly used paths)’
         potential has a relevant structure of ‘field of adjacent structures’
         concept has a relevant structure of ‘network of generalized structure & distorted variant structures’ or ‘sub-network of system network objects that interact with a conceptual attribute’
         change has a relevant structure of ‘core functions’
   if the problem is ‘find the cause of variable x’:
      relevant structures to use as the connecting function format include specific implementations of general solution-finding structures (sequence/filters) like:
         specific ‘sequence’ structures, like:
         direction
         specific ‘filters’ with direction, like:
         same direction as cause:
         dependency/requirement, inevitability, causative power, causative position/degree relative to that of x
         opposite direction as cause:
         counterexamples
         limits on causation
      query intents for relevant interface objects (once interfaces are applied) include:
         interface object ‘causal variable network’ query:
         ‘find variables further up the sequential causal network than x that could cause x with no counterexamples’
      solution format:
         ‘causal variables on sequential causal network with causal structures (inevitability) passing filters (no counterexamples)’
core problem type structures (reduction, expansion, organization, matching, standardization, regulation, prediction/derivation (missing info), limit/change conflict resolution, error-to-resource conversion, optimization) & optimal solution formats & format structures for each
   optimal optimization formats include network path-finding
   optimal reduction/expansion formats include change type isolation as shape dimensions after structural assignment of problem attributes
   optimal organization formats include layered networks & vertex variables
the problem is the solution in a different format, or a piece of the solution (problem being a sub-optimal state to optimize, or a difference that shouldnt occur, and the solution being a set of constraints forming boundaries, or an optimal structure to construct)
   filling problem
      missing info problem: the solution format is the complete structure
      optimization problem: the solution format is the variables/system organized to comply with/fulfill the metric to optimize
      aggregation problem: the solution format is the aggregation method to form a structure (like combining core functions to get a function for an intent)
   limit problem
      constraint problem: the solution format is the removal/invalidation of that constraint
   reduction/decomposition problem
      complexity reduction problem: the solution format is the set of variables that reduces complexity of the problem
      randomness reduction problem: the solution format is the set of variables that can replicate a semblance of randomness
      problematic structure: the solution format is reducing the structure (identifying variables & invalidating those variables)
   organization/mapping problem: the solution format is the set of relevant components in the right structure (positioning & connecting them)
      conflict problem: the solution format is positioning the conflicting problematic vectors so they dont intersect
      balancing problem: the solution format is the distribution of resources nearest to a balanced state (subset of matching problem, by matching distribution across positions)
      combination problem: the solution format is the set of components in a combination structure that doesnt contradict combination rules (components fit together, like ‘finding a system where a function can execute’)
      connecting problem: the solution format is the set of functions that connect the components, in the position where they act as connectors
   finding problem
      discovery (insight-finding) problem: the solution format is the set of generative/distortion/core functions or the set of filters to find the insight
      route-finding problem: the solution format is the route between two points that doesnt contradict any solution constraints and/or optimizes a solution metric
   other solution formats would be for adjacent/causal problems, solution formats that invalidate solving the problem, etc

Example of Selecting Problem/Solution Format
examples:
   every problem can be framed as ‘reducing solution space’, but some problems are more adjacent to this format than other problems, such as:
      ‘find the one item in the set that matches the filter value’, which is more adjacent to ‘reduction’ operation because it involves a solution output format of a lower quantity than the original quantity, specifically a quantity of one, which implies that the original quantity is greater than one, given that this is framed as a problem that is not solved yet
      problems have many possible formats, so an initial problem to solve is ‘reducing the solution space of possible formats to the one most adjacent format’
      the correct format is important to find, bc some formats will make the problem trivial to solve or solvable with existing methods
   as another example, a prediction function can be formatted as a problem of:
      finding causal network of variables (root/direct cause in structures of inevitability, lack of cause in interchangeable alternates)
      finding variable network connected with functions (apply ‘randomize’ to root cause variable, then apply ‘specialize’, then apply ‘standardize’)
      finding variable structure network (boolean causing vertex variable causing spectrum variable)
      mapping variables to influencing & interaction power (to influence & interact with other variables)
      isolating & filtering variables in data set by impact/contribution, filtered by probability of coincidence (coincidental structural similarity between independent variables & actual causative variables, leading to secondary structural similarity in apparent relationship to dependent variable)
      finding coefficients of variables in data set
      standardizing data set to a subset of variables (like a vertex variable) so core/unit functions can be applied
      inferring other variables not present in data set
      allocating randomness to explain lack of predictive power of independent variables & changing prediction function state
      finding the data set's distortion from a base/central/standard data set having those variables
      finding the probability of a prediction function given a data set (or vice versa)
      finding a line/cluster/point (or generalized structure) averaging the data set relationships
      finding concepts & other interface objects in the data set (concepts like ‘power’ relevant to predictive/influential potential)
      filtering data set by which data can be ignored (outliers, corrupt data, randomness, worst/best case, prior outdated data)
      finding a statistic representing target solution info
         does ‘average’ represent the relevant solution ‘prediction function’ that is best able to predict y across adjacent/derived/given data sets, or is there a better statistic, like:
         ‘weighted average’
         ‘subset average sequence’
         ‘emerging average given state data’
         ‘derived average given randomness injection’
         example of filter for selecting formats
         why shouldnt everything be formatted as a network (why should you use multiple interfaces or formats)
         everything can be depicted as a path on a math/language symbolic map, including insight paths, so why shouldnt that map be used to solve every problem?
         1. all formats have assumptions embedded which distort the format from the central format (no structure, or randomness), having associated useful intents
         2. some definitions of complex components would require other structures than a single network path to be fully defined, like:
         a layered network query such as a loop, which would be more optimally (like clearly) structured in another format, like a function network
         complex functions/concepts could have very intricate structures on a language/math map, which would be more clearly defined on a function or core component network
         paths between other paths
         paths between attributes of nodes on a path rather than the whole node
         multiple paths depicting the system context forming a sub-network around a path
         the system interface where agent interactions occur or where stressors are clearly modeled is therefore the best format for some solution automation queries
         3. the standard network format assumes functionality & attributes should be bundled as components like objects/agents/words/concepts, which may not be optimal for queries like identifying conceptual structures or variable structures
         even the attribute format assumes that some attributes should be grouped, and assumes values for certain attributes, where layers would be a better structure for attributes
         depending on the interaction level, querying a comprehensive map including all functionality/attributes can be computationally prohibitive
         4. the interaction functions of solution components (like cause or intent) arent automatically defined on a language/math map
         what type of query to run when the problem to solve is answering ‘why’, having an answer using the ‘because’ or ‘reason’ nodes
         cause/intent/concepts/systems/potential/change arent immediately clear from the language/math map, where they would be in a format using those interface structures
         5. some concepts/functions/attributes/components will necessarily be missing from the map until theyre added to the map, and some terms are unnecessary, and some are false
         missing components: components no one has used yet or thought of will be missing from the map
         unnecessary components: you dont need every interchangeable synonym or every number to effectively communicate a path
         false definition: some definitions would be defined suboptimally, giving incorrect query results until corrected
         the components wouldnt have the definition routes specialized for different interfaces (like abstract paths generating or defining a component) that enable quick identification of connections & other useful structures
         false variation: some changes to a language map would seem like variation but would actually not add much potential in terms of novelty/uniqueness in identifying a new concept
         6. the definition of difference in a standard language/math/symbol map might not be the best organization for queries, requiring other formats like central core functions with distortion & interaction layers around the center

Example of Identifying Query-Changing (Invalidating, Embedding, Stopping) Conditions During an Interface Query or Interface Query-Generating Query
queries are implementation of components of control flow (supply: decision/action/function, demand: problem/error/task/conflict/limit)
example: execute a query to find structures of ‘high-variation’ in a data set
   identify relationships within a variable (across potential values for that variable)
   identify relationships within a variable's state changes (across potential values for that variable across its lifetime)
   identify relationships (interaction functions & types) between variables
   identify relationships between variable structures (subsets, combinations, alternatives) & variables
   identify variable types (proxies, root cause, interdependent)
query-changing conditions
   standard control flow conditions
      query-stopping condition is where its clear the data cant:
         fulfill the optimization metric or fulfill it more
         find the info or find any more
   meta conditions
      query-invalidating condition is where the data set invalidates the concept of variation or data
         when a query has identified type/relationship/pattern info invalidating the data
         when the data is not a source of truth (state has changed but data has not & has no variation and is not data anymore, if data is a source of truth)
         when a query has identified a function to reduce the variation/data without losing info
         or create a function to do so
         or identified a need to trigger an embedded query to create a function to do so
         and has identified & organized resources to create that function or execute that query, after identifying its need for the function/query (AGI)
   query interaction conditions
   query-connecting condition is where the query identifies that another running or previously run query might have identified useful info relevant to its task
      examples:
         a query that identifies similar structures ‘difference-reducing/increasing structures’ or ‘similarity-filtering structures (leaving just difference structures)’ might find the high-variation structures quicker
         this alternative query could be found by applying the concept of ‘similarity’ to the ‘query’ object, allowing for the possibility that the query was almost correct
         a query to identify query metadata and apply those metadata variables to generate other alternative queries
         query metadata examples: accuracy, side effects (like unintended functions built during processing)
         generating more accurate or faster alternative queries by applying optimization structures (like alignment, info/function re-use, etc)
         a query that identifies ‘change-reduction’ structures (like types or interfaces) could be more efficient than this query to find high-variation, which may miss embedded query opportunities for embedded structures of change in the data (data about variables/functions)
         how could the original query know to check for such a query running in parallel?
         identify problems with its own query metadata (execution, design, connectivity, progress, probability of success) & calling query to generate alternative queries that optimize on problematic structures like performance metrics (execution time vs. relevant info found)
         identify problems in the original problem of the query (sub-problems of original problem, encountered problems like a missing function to derive)
         apply structures of robustness by default, like apply ‘alternative’ to ‘query’ object to run alternative queries by default, filtering by difference or relevance to maximize probability of finding useful info
         identify relevance structures that would be useful (such as useful for sub-problems identified initially or encountered during execution, or planned problem to solve later in original query)
         it could apply the concept of ‘type’ to itself (self-aware that it's a query) by abstracting the ‘query’ concept, identifying its type, and querying for other queries of that type
         identify that its processing was not finding info as quickly as typical queries asked to find structures of concepts like ‘variation’
         it could identify that there is another route to the info during its processing
         by examining data for variance, find a structure consistently causing/generating variance that relates to change reduction
         it could execute some of its processing using conceptual core structure analysis, creating combinations to identify concepts (related to query concepts like variation & data) like ‘change reduction’
         it could identify that a query-invalidating condition that reduces the variation in the data set has been met in another query
         it could use concepts like ‘equal’ and ‘opposite’ to apply a counter-query to check for the opposite structures, which can be faster
         just like checking for a difference may be faster than checking for a similarity or vice versa, or checking for a limit/conflict may be faster than checking for a function
         it could apply concepts related to the definition of ‘change’ such as ‘potential’, and identify that potential increases with more change structures, particularly change-expanding structures, the opposite of what this query is looking for
         then using the output of such analysis types that can supply relevance structures, applied at intervals or decision points during its own processing, it could check for a query running with intent (or inputs, side effects/outputs during/after processing) to:
         identify ‘change reduction’ structures
         generate a function to generate ‘change reduction’ structures
   query-embedding condition is where an embedded query is required
      in a data set is data about functions/variables, an embedded query might be used to find embedded variation in embedded function/variable relationships/structures
         data about functions/variables would expand the possible variation in the data set within each column/variable, with change types (functions/variables) as data
condition types
   invalidate query (compare & find alternative solution)
   embed query (correct an info gap)
   connect query (delegate processing to another query)
   stop query (apply a metric)

Method described in claims includes interface query examples.

Example of applying an info component (problem) definition in the problem space system to find solutions for problem types & structures (like sub-problems)
general method:
   apply general solution automation workflow insight path:
      ‘apply problem interface (standardize problem, identify problem types & sub-problems) or core interface (generate problem types), apply structural & info interfaces (to find structural, specific info implementations of problem types relevant to the problem space), then look up solutions to those specific or general problem types, sub-problems & structures, & apply solution filters’
   with specific interface query:
      apply info interface (problem definition) to identify problem metadata like cause & find problem metadata like problem cause types, or apply core interface to generate problem types, or retrieve index of problem types in data store
      find problem types causes (problem types caused by problem types)
      identify known possible info problem types (specific problems in problem space)
      match error types with info problem types by applying structure to error types (‘missing resource’=>‘missing function input info’)
      find matching solutions for error types once linked to info problem types (‘generate default param value’, ‘predict probable param value’)
      filter solutions with filters like ‘completeness of error types handled (‘solution that handles multiple missing resources (missing function inputs & missing code dependencies)’)
specific query to identify problem types within a problem space formatted as a system
   identify error root cause types using combinatorial core analysis
      find components
         structural mis/matches
         intent mismatch between function combinations across layers
         unnecessary structures
         missing structures
      apply components
         apply combinations
         combine components in various structures
         inject componeents into other components
         apply changes
         remove/add limits/rules/assumptions
         use alternate paths
         switch expected with unexpected components
      build components
         function sequences granting access
   find error types caused by those cause types
      the ‘structural mismatch’ error type causes error types like:
         lack of system/context-function fit (function-scope mismatch)
         lack of rule enforcement (function/responsibility mismatch, expectation/usage mismatch)
         lack of intent restriction for using a function (intent mismatch)
   filter caused error types by which generated errors would cause specific (info) problem types (process failure, access vulnerability, corrupt data)
   identify specific errors of filtered caused error types, organized by interface
      lack of intent restriction for using a function
         malicious function sequences matching validation requirements
         breaking input/output sequence for later functions
      lack of system/context-function fit:
         incorrect permissions for context
      lack of rule enforcement
         unhandled function inputs
         granting cache access to unauthorized scripts
      match specific interface (intent, structural) error types with specific (info) problem types (apply info interface to error types)
         lack of intent restriction
         breaking input/output sequence for later functions
         injecting function with less validation in function chain
      match specific interface (intent, structural) error types with solution types
         intent mismatch: align intent
         lack of intent restriction: reduce intents supported by function (re-organize logic, add validation)
         incorrect permissions for context: scope permissions, generate permissions for a context/intent & check for a match before executing
         breaking input/output sequence: check that all valid/supported function sequences are maintained
         lack of rule enforcement: check that all rules & rule structures (like sets or sequences) determining resource access are enforced, or rule gaps where error/attack types could develop are closed
      reduce by solution types that cover the most error types without contradicting other solution types or creating additional unsolved problem types
         intent-matching covers multiple structural error types
         system-fitting or structure-matching as a superset of intent-matching

Example of Alternate Interface Queries
interface queries are structures generated by the program in response to a user request for info, to find/derive/generate info, such as how to connect two info structures/formats
alternate interface queries
1. start with standardized problem definition
   apply solution automation workflow ‘vectorize problem’:
      start with inputs & outputs and connect
      apply function interface
         find functions that have a data set as input and a function as output
         filter by functions whose outputs are evaluated by a metric, indicating variation in output metric like accuracy
         filter by functions that are later updated with a lower-dimensional function, indicating the original function was a guess (approximation/prediction function)
         filter by functions that are associated with a data set used as input to a function that generated the function
         filter by functions that are tested on variable data sets, indicating the function is a guess that can be optimized
         filter by functions with a high number of inputs
2. start with standardized problem definition
   apply structure interface: apply structural interface to problem
   find/generate/build relevant solution automation workflows
      generate a structure of relevant solution automation workflows to execute
         tree of solution automation workflows
         1. ‘find composing functions of set of functions with input-output prediction accuracy range within x’
         2. ‘find relevant component definitions & apply (finding matching structures), then integrate’
         3. ‘break into sub-problems & integrate sub-solutions’
         merged solution automation workflow tree (workflows 2 & 3)
         find relevant component definitions
         apply component definitions (finding matching structures in problem)
         integrate applied component definitions into a component connecting structure
         find sub-problems of the connecting structure (network of unsolved functions connecting nodes)
         solve sub-problems
         integrate sub-solutions in original connecting structure (network of solved functions connecting nodes)
   apply merged solution automation workflow
      identify sub-problems of problem structure
         method to find sub-problems of solution automation workflow
         1. find/build/derive structure of components (objects)
         2. apply structure of components
         3. find/build/derive structure to integrate components
         4. apply structural interface to integrate components
         5. find/build/derive sub-problems of component structures
      identify integration method of sub-solutions
         integration method of solution automation workflow
         6. find/build/derive structure to integrate sub-solutions
         7. apply structural interface to integrate sub-solutions
         8. find/build/derive solution structures (filter, combination, reduction, connection) to optimize integrating/sub-solution structures
         9. apply solution structures to integrating/sub-solution structures
         10. change integrating/sub-solution structure to match additional solution structures
         11. integrate change sets to match the most solution structures

Example of Applying Solution Automation Workflow
apply ‘find’ operation instead of build/derive/apply where possible to generate interface query for problem ‘find a prediction/regression function/line’, with sub-problems:
1. find/derive/build structure (definition) of components (regression)
   ‘find line minimizing distance from data’
   apply structure (definition) of component (regression)
      find specific structure of component
         ‘find line minimizing perpendicular distance between line & data for all points’
2. apply structure (definition) of components (regression)
   apply component input (data) to component
      sub-problems:
      A. find component definitions
         sub-problems:
         I. find definition of distance (and applicability to other comparisons like adjacence of data points)
         ‘area of perpendicular line as height with parallel distance to adjacent data points as width’
         II. find definition of data (and related objects like data points)
         ‘sets of variable value sets’
      B. apply component definitions
         sub-problems:
         I. find structures matching component definition (intent: check that definitions match inputs, as a proxy for relevance)
         distance structures: area, line, height, width, parallel, perpendicular, adjacent, data, points
         data set structures: data point, variables, values, variable value sets
3. find/build/derive structure to integrate components
   find structure to connect distance & data set structures, according to definitions
      ‘find a line whose perpendicular height to data point & parallel distance between adjacent data points form an area that is minimized across data points in the sets of variable value sets’
4. apply structural interface to integrate components
   apply function structure to connect components
      find specific functions to fulfill the component integration structure found in 3 (match the component integration structure & its specific application with the solution structure)
         ‘for each data point, calculate area between point & line, aggregating area at each iteration, then check for structure change to minimize aggregate area’
5. find/build/derive sub-problems of component structures
   optional:
      select between component structure alternatives (different valid definitions that dont contradict solution metrics or solution intent)
      find function to filter data
         find specific structures to integrate sub-solutions
         filter outliers beyond range
   find function to calculate distance (between line & a data point)
   find function to iterate data points (consecutively, most similar/average first, etc)
   find function to aggregate area (calculate total difference between line & data points)
   find function to minimize aggregate area (function to add/change params of regression line function)
6. find/build/derive structure to integrate sub-solutions
   apply(‘function to minimize aggregate area’, apply(‘function to aggregate area, apply(‘find function to calculate distance’, apply(‘function to iterate data points’, data points))))
7. apply structural interface to integrate sub-solutions
   execute the above function structure with injected calls to apply( )
      apply( ) executes logic:
         find structure using param1 on param2
8. find/build/derive solution structures (solution metrics, in the form of a filter, combination, reduction, connection) to optimize integrating/sub-solution structures
   find solution metric for prediction function
      ‘prediction function has high input-output connecting accuracy rate’
      ‘prediction function uses fewest possible variables’
      ‘prediction function can maintain an accuracy rate x with data change range y’
9. apply solution structures (metrics) to integrating/sub-solution structures
   apply solution metric for prediction function
      change variables & structures in data set with a change range to use as a test for prediction function
         find variables in data set (different change types)
         find structures in data set (causal structures, dependency structures, alternative structures, independent structures, random structures, info structures like variable sets)
         change variables/structures in data set according to change range x
         test prediction function on changed data sets
10. change integrating/sub-solution structure to match additional solution structures (metrics)
   find solution variables/structures
      base line
      connecting lines
      most different/similar subsets of data
      most explanatory variables
      spaces where variables can be depicted in fewer dimensions
      standardizing variable structures (variable sets that change within a range x on parameters a, b)
   generate specific tree of alternative solutions
      use average line as a base line
      start with lines that connect most average or most different values & integrate
   apply changes to check if additional solution metrics are fulfilled
11. integrate change sets to match the most solution structures
   find change set of solution variables/structures that produces highest count or highest-prioritized count of solution metrics fulfilled
   merge change sets to generate combination change sets & re-test to find higher counts of solution metrics fulfilled

Example of Interface Analysis Applied to Explain Lack of Perfect Predictive Power of a Variable (Like Cell Structure)
structural analysis of components (like cell shape/surface) is insufficient as a predictor of functionality bc it's missing info about:
components
   other/possible components & their structures (other possible pathogens, foreign cell types, in other ratios/positions)
      other/possible components with similar/contradictory shapes that might be interfering
         like similar receptor/binding shapes that leave no room for the cell type being examined
internal cell components not measured or formed unless found in a particular environment context
change types
   changes to the host system structure (like nerve damage)
   changes to forces governing change (like motion, as blood flow) in the host system structure
   not measurable info
      hidden non-structural variables (like blood flow/pressure, electrical effects, or prior exposure to nutrients like vitamin d triggering timers) or variable sets with similar net effects (activated lifecycle)
      distortions commonly found in different cell types with same structure bc of different positions
      functional implementation differences
         different cell types have different method of achieving the same function using the same components, in a structure that varies within the data set but not enough to indicate different method
component interaction dynamics
   interaction level
      cells with same structure might operate on different interaction levels, given different position/system
   structures of interaction object components
   a cell with equivalent DNA might encounter ‘jumping gene’ functionality in one system position, where an equivalent cell in another position would not
determining interaction attributes/functions
   like how attributes like aggressiveness might be determined by missing info (indicating why one cell type would succeed at binding & another of a similar/equivalent structure would not)
limit/threshold dynamics
   sample data might leave out variation in the form of determining cell type attributes like size above a threshold with emerging behaviors, or potential to change that attribute triggered by the environment
state dynamics
   false equivalence: structure might be measured at two equivalent states across two different cell type lifecycles (like evolutionary paths or distortion patterns), giving illusion of equivalent structures
system dynamics
   structural metadata (like position, which determines local system & adjacent cells/functionality)
   invalidating functionality
      system that deletes duplicates, where a particular cell type is handled second bc of some attribute (like size, indicating it needs to be broken down first), so its always found to be the duplicate & is deleted
   functionality that is activated in environments & not obvious with structural analysis
      like a function that folds dna/proteins in a way that has more errors than other folding function in a particular environment
   sequential dynamics
      exposure to a pathogen might trigger a function in response to a cell type with a minor distortion that becomes determining in edge conditions

Interface Queries for Problem ‘find a Prediction Function’
apply info (definition) interface
   apply error definition routes/attributes/functions/objects/structures
      identify error types for problem ‘find a prediction function’ to use as filters of solution space
         false equivalence
         similar routes to different answers
         this implies similar patterns in variable structures & interactions across data groups
         overlap
         lack of differentiating variables in data set
         false difference
         merging/imminent similarity/equivalence
         functions that can act on other functions to produce a false or real equivalence to another function
         alternative routes to the same answer
         identify all the alternative structures (routes, combinations, trees) to an answer between function components like variables, data sets/subsets, & neural net components like weight path patterns, and the differentiating factors & vertexes, then use that to implement a filtering structure to sort through them to rule out the most possible answers the quickest
         alternative answer types
         identify all the different variable/function combinations that could create the most differences in similar answers (such as different types or contexts like a separate function for outliers), and a filtering structure to apply these as variation-reduction functions
         these filtering structures can act like interfaces, reducing variation in the possible answer set
         equivalent combinations
         alternative variable subsets that act as proxies to an answer
         equivalent variable structures
         find variable structures like functions that approximate other variable structures like variable networks
apply change interface to find variables in a problem statement
   find isolatable change types
      if the problem is ‘predict movement of object’, this means: ‘find change in possible orthogonal directions’
         filter out redundant variables (like if variable A/B+randomness constant can be replaced with variable C+another randomness constant)
         filter out variables or variable structures like combinations that look like randomness to leave sets of variable/s
         find prediction function for variables with randomness excluded
         apply degree of randomness with randomness accretion patterns & interaction structures (like other objects on interaction layers) to prediction functions once variable dependencies are described, to generate prediction function set or prediction function with distortion vectors for possible ranges, then test on data
   variable sets that cant be filtered out can be considered sub-problems to solve (‘filter out this variable set’) in addition to the original problem of ‘finding a prediction function’, as extra filtering tests to apply before the solution is selectable
interface query using concept-structure interfaces for problem ‘find prediction function’
   find solution filters
      find range of error allowed for solution
   convert to problem interface
      predict missing info ‘future state of variables’ with input ‘past info’
      standardize to structural interface
         find vertex concepts
         ‘find prediction function’ using past info involves:
         risk structures like: possibility that an unknown structure is causative
         randomness structures like: possibility that known structures will be distorted by randomness
         change structures like: possibility that known structures will change & info needs to be found/derived to update variables
         combine risk structures, randomness structures, & change structures
         filter which combinations match data
         filter which combinations match data within range required by solution filter
general interface query example for ‘find prediction function’
   change: find highest-variation variables in problem statement
      structure: find combinations/subsets of variables
      cause: find dependency structure of variable subsets
         function: find input/output sequences of variable subsets
         structure: filter the sequences by whichever sequences link the source/target structure
         problem: solve sub-problems of organizing variable subsets
         structure: aggregate sub-problem solutions
specific version of general interface query example for ‘find prediction function’
   change: find highest change problem variables in problem statement
      which probability distribution it is
      variable values given
      whether alternate probability distributions can be ruled out using constraints/assumptions/parameters/change types & other info of problem
      sub-problems
      sub-problem structure (organizing the sub-problems)
   structure: find subsets of variables
      example problem variable subsets:
         missing info+variables values given+sub-problems
         probability distribution+variable values given+other problems or problem patterns
   cause: find dependency structure of variable subsets
      missing info+variables values given+sub-problems
         with the missing info & variable values given, you may be able to infer the probability distribution (though not always if the problem statement is ambiguous) and derive the sub-problems to solve
      probability distribution+variable values given+other problems or problem patterns
         from the probability distribution & variable values given & other problems, you may be able to infer what the missing info is given questions usually asked with that distribution
      function: find input/output sequence of variable subsets
      structure: filter the sequences by whichever sequences link the source/target structure (variable values, probability distribution & missing info, ‘probability of event’)
         problem: ‘predict probability of event A given event B & some parameter/condition C’
         sub-problems
         identify problem metadata (probability distribution, variables & values) in problem statement
         identify missing info (specific problem to solve, like ‘find the missing info that is a probability of a specific event’)
         identify alternate interpretations of problem
         filter alternate interpretations (to likeliest or the interpretation with no contradictions)
         match variables & values in problem with parameters of the probability distribution or relevant functions
         filter functions to functions with output type ‘probability’
         filter functions to functions with specific output probability matching missing info
         aggregate sub-problem solutions
         missing info:
         apply variable values to relevant functions to generate missing info (specific output probability)

Apply distortions to vertex interface queries for solution intents
vertex interface query: high-impact query which can be used for finding optimal solutions quickly or used as a base for other interface queries in interface query design
   query: reverse engineering solution metric with core structures as filters to find relevant metric structures
      problem statement: ‘find individual unit metric value in a container having equivalent & different components, without a function to measure individual unit metric value, and given total container metric value & unit count’
         find relevant structures of the metric
         apply insight relevant to ‘calculations’: ‘apply the same standards when calculating if possible’
         apply concept of ‘similarity’
         find relevant structures having the same metric
         find relevant structures to ‘unit’
         apply core concepts/structures to problem system structures
         apply core structures of ‘combination’
         relevant structure: set of units, having an aggregate metric, usable input to an averaging function
         apply core concept of ‘opposite’ or ‘not equal’ and the core concept of ‘total’ (the complete set of all components in container)
         relevant structure: set of non-unit components in container, having the same metric, usable input to a subtraction function
         find most measurable structure (with greatest accuracy or fewest steps) out of the relevant structures having the same metric
         find calculation relationship between adjacent proxy metric of relevant structure and original solution metric (individual unit metric value)
         calculation relationship between sets of not-equal components and equal components to the individual unit metric:
         calculation relationship: “subtract not-equal component set metric value from total value, and divide by unit count to find individual unit metric”
         to find this relationship, execute the opposites/reversals of the operations to find the relevant structure metric values
         ‘subtract’ is opposing function of ‘combine’
         ‘combine’ was executed to get the list of sets of components (not-equal components & equal components)
         ‘divide’ is opposing function of ‘combine’
         ‘combine’ was executed to get the set of equal components, relative to the individual unit
         these two combine operations were used to create a path from the individual unit to the set of total components in the container
         they can also be applied in reverse to get from the given total container metric value to the individual unit metric value

Method described in claims includes examples of interface operation logic.

Apply interfaces to derive an insight like ‘power is responsibility’
apply causal interface to identify connecting function ‘power is responsibility’ (which is also an insight)
   power can be defined in causal interface components as ‘causative potential’ (its the input reason for change in a system, including changes preventing changes)
      given that it has structure ‘change input’, its also a source of other change types than intentionally triggering the correct function (errors, side effects, changes to errors)
      changes to fix errors are related to the concept of ‘responsibility’ (definable as ‘work that isnt incentivized but is necessary’)
apply structural interface to identify connecting function ‘power is responsibility’
   ‘aligning error & fix sources’ also corrects the ‘power source distribution imbalance’error, which is another way to derive this insight, using the structural interface (correct distribution imbalance with alignment)
   identifying the ‘similarity’ (a core component of structural interface, applied during a standard application of interface) in the ‘direction’ structure, between power & side effects (including errors) as similar to the direction between power & fixes
   identifying connecting functions positioning power as an input/required structure to fixing errors:
      identifying that ‘fixing functions’ have an input trigger requirement like any other function, and function triggers therefore have power to fix errors
      identifying that if something can generate a ‘fixing function’, it necessarily has power
      identifying that if power is necessary to change a structure, by process of elimination, nothing else could fix an error

Apply Interfaces to a Concept
apply interfaces to concept of risk to find relevant interface objects like solutions to risk error type, risk structures, & other risk metadata
   risk: adjacence to negative events (error types)
      risk structures:
         cascading risk
         compounding risk
         interacting error types
         adjacence of an error type to another error type
         adjacence of input/output & other interaction formats enabling interaction
   solutions to risk:
      distributing errors or otherwise ensuring they cant interact
      making sure if an error occurs, its at a dead-end trajectory where its side effects dont impact the system
      distributing info sources to gather info on imminent risks (robot that can distribute a set of sensors to pick up signals it otherwise couldnt, like behind opaque objects)

Apply an Interface to an Interface
apply info & physics interface to math interface
   math is a connecting interface of abstraction & structure bc it maps fundamental structures to abstractions
      math describes info (stabilized structures)
      relevant questions:
         what structures have stabilized in the math interface, so math can be applied to describe stabilized structures of math
   math interface as info (certainty) physics, specifying:
      what can be known/calculated & approximated
      what can be predicted
      what certainties can be connected using numerical relationships (like how logic specifies what inferences/conclusions can be connected)
      determine what can be calculated by applying info & physics interfaces
         when info doesnt exist, math cannot solve the problem
         with info defined as ‘stabilized energy storage’, at what point does the definition of info break down:
         type level interactions
         gaps in the possible change ranges of symmetries
         structural changes
         lack of alignments, similarities, efficiencies or other structures enabling info to accrue/develop/stabilize
         incorrect assumptions
         reversibilities in time symmetries, or symmetries that are theoretically irreversible without a concept of symmetry operations
         constants like inevitabilities, absolute (acontextual) impossibilities, or limits on variable value ranges
         limits in how info overflows (info that cannot be stored in an existing structure) can be predicted (structures built to store it)
         building different info storage structures (different from brains, networks, topologies, matrices, & probabilities, like interfaces & superpositions) can change how patterns of uncertainty-to-certainty conversion (like with uncertainties n degrees away from pre-existing certainties) occur & their probabilities of occurring
         missing dependencies
         gaps in conditions enabling energy storage (definition of a fraction is stable while the numerator/denominator are still defined, complex numbers defined using the definition of square root of −1), creating a symmetry of stability, where the efficiency created by core functions of a new interface can dissolve once the functions buildable with core functions overflow the interface, so functions may dissolve to randomness when absorbed by other systems
         changes invalidating the unit structure combined to create other structures (where basis vector is not defined)
         where definitions used by info definition (value, difference) break down
         where certainty is universally distributed & no uncertainties are possible, so a definition of certainty is not needed
         where certainty is not allowed by the system
         system has distributed randomness injection points, or structures of certainty like interaction levels are prevented from developing

Apply interface analysis (like apply an interface, apply an insight path, apply a generative function, or apply a solution automation workflow) for an intent (solve a problem, complete a task) includes example implementations like the following.

Apply structural interface to generate variables in a system
identify changes that lead to development of a ‘concept’ in a system:
   an object begins aggregating changes (like functions/attributes) in such a way that it develops unique interactions that differ from those calculated by a simplistic summing of the interactions of its components
   example: a system may develop a concept like a ‘layer’
      structural definition of a layer: a set of components that separates other components & their interactions, inside a containing boundary
         this definition differentiates it from a boundary, limit, line, or container structure
      the definition also has dimensions beyond a simple line
      the layer may aggregate functionality, such as:
         being stacked or combined to create larger layers or structures on top of a layer
         forming a base for interactions to develop on, if its a vertically stacked layer
         acting as a filter, if there are openings in the layer
      so the layer is not only measurably different from similar structures, it may also have significantly different functionality, earning it a unique term (meaning it has developed into a ‘concept’ in the local system)
      the variable of ‘structure’ can describe the layer & generate it, but it doesnt capture the full definition of the ‘layer’ concept
      other variables are necessary to fully describe the layer, such as:
         adjacent structures (line, container, limit, boundary)
         core function (stack, combine, bridge, support)
         adjacent functionality (filter, separating interaction layers)
         default structure (vertical layer related to stacking function)
      because it stabilizes into a useful unique component, the layer concept begins to act like a vertex variable and/or an interface, since it starts becoming causative of changes due to its stability (rather than just being the output of changes to similar structures or iterated core functions or aggregated variance)
      concepts in a system can be local interfaces that are useful to use as standards for comparison
         standardize to the ‘layer’ structural interface
         standardize to the ‘local system structural concept’ interface
   so you can generate the sequence of a set of variables for a system by which change type structures are stable enough to act like concepts/interfaces for a given stage subset in the sequence of system development
      system metadata: invalidating/triggering/development conditions
you can also apply core structures to generate change types (multiply a number by the structural concept of ‘opposite’ to get the ‘sign/direction’ variable)
   variable definition route:
      isolatable, measurable change type
   component generation: identify components of a system & generate possible change types that enable/optimize interactions between those components
      core generation: identify core change types that can be combined to create other possible change types & generate other possible change types & filter
      subset generation: identify subsets of a system's components that are sufficiently stable in functionality/attributes to interact with other subsets without invalidating the system
   limit generation: identify limits of a system & generate possible change types that can develop within those limits & filter
      reverse generation: generate required functionality in a system & derive possible variables that could produce it & filter
   filter generation: identify & apply filters that determine variable development functions (like change combination, change metadata pattern, change coordination functions)
      apply ‘variable’ definition filters: generate possible isolatable/measurable change types & filter
      apply ‘efficiency’ definition filters: generate structures that would be efficient & check for components that could generate those structures
      other example filters:
         are there resources to sustain this change type
         does this change type contradict a system rule
         is there a reason/intent/usage for this change type that is not fulfilled elsewhere (by metrics like adjacence to justify creating the functionality)
         is there a system-invalidating force requiring a new change type
         is there another position that could use similar functionality to existing functionality that is inaccessible in that position
         is this change type adjacently buildable with system resources
         is this change type probable
         would this change type trigger changes that invalidate the system or reach stability
         how would this change type interact with other change types
         does the environment system change enough to justify developing another or extra change types

Apply structural interface to identify false info across user web requests
apply intent interface:
   check with intent store (site) if a request for an intent (request password) was just made by the user, to validate messages
   apply pattern interface:
      check if user access patterns (like ‘navigate to site, then check email for site password reset’) match that intent

Apply structural interface to predict trend convergence
trends
   micro internet markets
   micro/specific app favor markets
   violent power transitions
   competitor/competition bans/taxing
   currency/wi-fi competition & dictators as a source of stability
   anti-democratic activity as a specific case of anti-trust activity
   investment in job creation/antiquated tech subsidies
   customer product lock-in
   dependent product price-raising
   drug discovery automation
   all-service companies
   info derivation tools
   temporary/sequential info markets as a social mobility/equalizing tool
   delegation of high-cost/low-interest problems to AI
   ending resource inequalities (tech, energy, internet)
   hacking targets (democracies, big consumer markets like traders/gamers)
   labor trends of balance between priorities (organization/innovation/optimization/integration/cooperation/research)
structures
   error type structures
      cascading errors
      AI is applied iteratively to tasks that people dont want to pay attention to bc they assume lack of relevant or changing variation, which may include monitoring AI errors or designing AI tests
   interacting trend trajectories
      price manipulation for investments in systemic price reduction (ending resource inequalities necessitating competition for moats)
      markets for info, decisions, risks, intelligence, potential, justice, laws, independence, problems/solutions, customization, organization
      competing prediction/computation tools: stats, system analysis, quantum tech, AI-optimized processing units
      AI as an error-correction tool for quantum tech
      checks & balances through competing evaluation tools:
         science experiment automation, automated testing tools, AI, quantum computing, system analysis, stats
      evaluation/info-derivation/prediction/computation tools as components of a system building understanding
      competing task runners: AI, robots, & gig workers
      contact-reduction & independence tools like 3d printing
      organization tools, encryption & dictator overthrow-planning/subversion, consensus-building, or dictator-manipulation
      organization of competition in a problem market, for important optimizations only
      market selection/optimization/automation

Apply structural interface to components like technologies to find emergent trends
tech, standardized to common terms
   movie: sensory info emotion triggers & info/abstract paths (stories)
   video game: decision visualization
   music: audio emotion triggers & info/pattern paths
   ai: prediction/generation
   ar: integrate visualizations with real sensory info
   screen: visualization interface
   video conferencing: visualization sharing
   text voting: decision aggregation
   drug: direct sensory info semotion trigger
   brain-scanning tech: visualize memories & thought processes
emergent trends:
   multi-player video game voting: applying voting tech of viewers to influence video game tactics/resources/problems/outcomes/decisions
   generative query: switch input of decisions to another decision-producing tool (audience voting vs. player/algorithm decisions), for randomness/customization/reality integration intents
   user character customization: applying AI to generate characters of real people or characters from other games to play as other players in video game
   generative query: switch input of character personality/story with another source of that info, for customization/reality integration intents
   memory-generated video game: apply ai & brain-scanning to generate a game based on memories
   generative query: change experience level or skills required (use memory as a tool or test memory functionality), for testing/customization/reality integration intents
   emotional/sensory alignment games: query for desired emotional path & map a game/video/audio/drug to produce or match that path
   generative query: change content-creation direction & other variables, from story=>emotions to emotions=>structure applied to emotion-triggering tools
   brain-development games: apply AI & brain-scanning to identify missing functionality in brains & generate game to develop that function
   generative query: use output of game (learning) as input assumption for learning intents using games as intent-fulfillment resource

Apply structural interface to solve problem by changing structures (like position) of interface objects, like functions & variables
add functionality (or associated attributes) with components with base/core functions included, components which can be connected with user-defined functions
   this can add functionality to products to reduce need for producing new versions
   physical sensors can use communications tech with varying required internet infrastructure (beacons/bluetooth/radio) to integrate with data, computers, physical resources, building blocks of robots
   physical components examples:
      use a sensor added to non-electric or non-AI-driven vehicles, pedestrians, & other moving objects on roads (animals, robots) to detect other objects or sensors & help avoid crashes by attaching sensor output as input to steering mechanism with a steering component (interim tech while waiting on market capture of EV & AI vehicles)
         can also be used to turn a cart or anything with wheels into a delivery robot, to reduce human traffic
         this can turn the delivery market into a sensor coding market to add functionality/integrations to sensors & the robots or resources controlled by them
      use a sensor (indicating position to lift away from) as input to another sensor (lifting sensor) with connecting function (fetch position to move away from, direct lift away from position, initiate lift)
         add sensors with user-defined connecting functions & prioritized sensor functions
         if a sensor on top of trash can has function “lift” and can take input like “heat motion in range”, add user-defined connecting function to another sensor not on lid that the sensor on top can use as a reference point to find direction to move in (away from other sensor)
   code components/functions
      user-defined connecting function like “query regularly for a function that can do this (publish, copy, export, search, build), and when found, add to querying component”
      find connecting function like ‘abstraction’ to add functionality like ‘handling other inputs’ or attributes like ‘flexibility’ and distribute flexibility to other accessible components
      hook a search function component up to input component (filters) using user-defined connecting functions (input filters to search on)
      user-defined connecting function to connect components like core functions/scripts/metrics (when this event occurs in the sensory input function, send signal to trigger other function)
         this is a way to abstract code (any function that can receive input data of that type) & code connections, delegating execution to code located with queries (find a function of this type or with this input/output) and modularize code as well as making it more connectible
   task: identify the core functions/components that can generate required functionality for most user intents without introducing security flaws (making hacking devices less adjacently buildable than common legitimate use cases)

Apply structural interface to identify relevant structures for an intent
for ‘identify’ intent, relevant structures include structures of difference (filters) and uniqueness (unique identifiers)
for ‘connection’ intents (identify/generate connection), a structure where components are only defined in terms of other components (by their relationships to other components), like a network or vector space
for ‘differentiation’ intents, a structure where the definition of difference is clear & applicable (can differentiate all different components)

Apply structural & conceptual interfaces to apply structures of concepts to functions to find prediction functions
apply structure of time (state) into algorithms (network state algorithm)
apply structure of hypnosis (multi-interface alignment) to algorithm (hypnotized algorithm is static & cant learn, which is an error type)
apply meta structure to algorithms
   an algorithm that cant see its own error types is one that cant:
      change its perspective/position
      change the variable creating the error type
      receive negative feedback for errors
      apply negative feedback to correct structure (like direction)
      identify costs (indicating why its an error, as in what resource is lost)
      structures that depend on the outputs of their distortion, becoming dependent on their distortion
      structures that cant develop a function to correct the error (a power source that cant develop a power distribution/delegation function)
organize list of structures required for system optimization & make diagram & generative insight path & query
   concepts
      anti-chaos structures (organization)
      lack of requirements (dependencies): an optimized system operates in a self-sustaining, self-improving way with as minimal requirements as possible with existing resources like functionality, and with decreasing requirements over time
      multiple alternatives
         example: having multiple definitions of cost avoid errors like ‘lack of flexibility due to over-prioritization of avoiding costs like pain’ and instead be able to sustain one cost type to reduce another cost type, for a duration like ‘as needed’ or ‘while advantageous’
      anti-complacence structures (checking for new error types that cant be measured with existing tools yet by always building new measurement tools)
      other structures for optimizing systems
         anti-complexity
         apply filters to remove info that is repeated without value added
         anti-trust
         apply tests regularly to system components & structures of them, checking it for new variance sources & error types as well as known sources/types
         anti-dependency
         apply solutions to optimize system that increase similarity of components in the direction of independence, distributing functionality across components (like cross-training)
         anti-static
         add solutions that dont remove possibility of generating other solutions/error types (thereby reducing the variation the system can handle)
   functions
      apply error types to check a system for known optimizations (error types like ‘structures that seem similar but are not’)

Apply structural interface to apply structural definition routes of adjacence (minimal units of work) to find efficiencies
find efficiencies in core functions (multiply, find integral/derivative, find efficient method to calculate difference) by applying structures of adjacence (core functions) and clarity (isolatable structures, definitions)
   find product of factors
      apply core, pattern, & structural interfaces
         find pattern structure of factor sets (function connecting factor sets) & use that to calculate using more efficient addition/subtraction operations
         find approximating function given pattern function (adjacent more calculatable pair with adjusting operation)
         find derivation function of a factor in a set, given another factor & pattern structure
   find function for integral
      apply core & structural interfaces
         apply combinations of core components (coefficients, powers, values) to find equivalence to area
   find function for derivative
      apply core & structural interfaces
         apply core structures (like unit) to reduce calculations
   finding method to calculate difference:
      apply intent, core, structure, change interfaces
         intent: differentiate data point clusters in a clear (easily measured) way
         identify problem metadata
         apply one-degree change to each attribute, like variable count
         add/subtract variable count
         list new components & component changes
         new variable
         new variable structures (combinations, connections)
         apply units of work to new components or changed components
         find functions of differentiating values (positive/negative, multiplication) & attributes (value range allowing very different values) for new variable
         add variable of differentiating values to make overlapping 2d clusters clearly separable in 3d

Apply structural interface to generate an assumption identification function
define ‘assumption’ with alternate interfaces, like info/abstraction, filtering for assumptions that cause errors
   definition route: any specific info is a potentially problematic assumption
   example of an assumption: solving the problem by asking ‘what function in the software caused the problem’ assumes that the stack variable is a constant (‘software’ part of the stack), when really other variable values should be examined
   since specificity is the root cause of the problematic assumption, remove specificity in the form of a constant by applying the opposite structure (change types to variable values)

Apply structural interface to identify & apply optimal structures to connect problem & solution, using alternative definition routes & error structures
original problem statement:
   ‘object is over-reduced’
identify optimal format to solve problem in:
   standardize definitions of problem system components
      standardized definition of ‘over’=‘excess’, which is a known error type causal structure
         standardized problem statement:
         ‘object has error of type excess, applied to reduction function applications’
   identify adjacent error structures & alternative definition routes of problem components (or iterate through error structures, checking each for fit to problem components)
      adjacent error types & definition routes of ‘excess’ include:
         imbalance
         solution format would involve finding balancing structures—a more abstract (less clear) solution format than a difference from a standard
         mismatch
         solution format would involve finding matching structures between object & the system context—also a more abstract (less clear) solution format
         difference from standard
         ‘difference from standard’ has a clear solution format, in the form of a path structure, from the standard (origin) format to the distorted (over-reduced) format
         this solution format is clear because it involves more core structures like ‘distance’, with clear mappings to the problem system components (‘difference’ mapped to ‘distance’ of ‘network path’ structure, measured in ‘number of differences’ as steps between origin & distorted object versions)
apply optimal format to problem:
   problem, formatted using distortion structures as an error structure:
      over-distortion, caused by over-applying ‘reduction’ function
   solution, formatted using distortion structures:
      reduction function of the reduction function, applied to un-distort distortions (‘differences from standard’)

Apply structural interface to apply structures of definition routes of a concept (usefulness) like conceptual attributes such as clarity/adjacence
function to check a format for structures of usefulness/relevance like clarity, adjacence to determine usefulness/relevance of the format to a problem
   check if ‘difference from standard’ is a useful (clear, adjacent) format for the problem ‘object is over-reduced’
      standardize problem statement:
         standardized statement: ‘excess’ applications of ‘reduction’ function to ‘object’ component
         find standardized statement components:
         ‘object’ component
         ‘reduction’ function
         ‘excess’ applied to ‘apply function’ function
         formatted definition: function.attributes[‘call count’] excess
         find structure of this definition:
         structure:
         difference (integer) between optimal function.call_count and excess function.call_count
         check for adjacent method to find structure in problem system
         find structure of a difference formatted as an integer, in a problem system formatted in standard formats
         iterate through standard formats for problem
         function network
         network of problem functions, including ‘application’ and ‘reduction’
         state network: origin state & excess state
         alternative format: state network with origin at center & distorted state, separated by distortion function nodes
         this format has a structural similarity between count attribute of ‘distortion function nodes’ and function.call_count attribute format, as both are in integer format
         check if this format is adjacent to convert problem to (low-cost, or similar)
         steps to convert problem to this format:
         map standard to origin
         map function.call_count to differences (steps away from origin), structured as distortion function nodes (representing the ‘application’ function that calls the ‘reduction’ function)
         map excess to distorted position, function.call_count steps away from origin
         if the conversion steps of that format are lower cost than those of other formats, try this method to see if the format is useful as well as adjacent
         check if applied format is ‘useful’, defined as:
         solves the problem
         makes the solution clear
         reduces the tasks necessary to solve the problem (connect problem & solution)
         once problem is formatted as a set of distortions from an origin, is the solution:
         reached (new problem format equals solution format)
         the format itself doesnt solve the problem—the object is still over-reduced
         clear
         the format adds clarity without losing info—the object & relationships are accurately represented, in a simple format
         fewer steps away
         the remaining steps to solve the problem involve connecting the new format (‘differences from standard (origin)’) with the solution format (‘object is not over-reduced’)
         remaining steps include:
         standardization of solution format
         converting standardized solution format to current problem format
         finding a connecting function
         example logic of remaining steps:
         standardize solution format:
         find structures relevant to problem & solution format
         ‘over-reduced’ and ‘not over-reduced’ imply the ‘opposite’ core structure
         apply ‘opposite’ structural definition to find structures relevant to the problem
         ‘not over-reduced’ applied to the problem can mean:
         ‘less reduced than excess position’
         ‘origin position’
         convert standardized solution format to current problem format
         convert ‘less reduced object than excess position’ to ‘differences from standard (origin)’
         ‘less reduced’ applied to excess position in ‘differences from standard’format has structure:
         ‘fewer differences (steps from origin)’
         fewer can mean:
         any integer less than current number of steps associated with excess position
         the converted solution format:
         ‘less steps away from origin than excess position’
         find connecting function of converted standardized solution format & current problem format
         find ‘opposite’ structures of ‘reduction’ function:
         find ‘opposite’ structures relevant to an ‘excess’
         reduce the excess
         convert the excess to zero (if zero is acceptable structure for solution format)
         remove the object in excess (if zero is acceptable structure for solution format)
         find ‘opposite’ structures relevant to a ‘reduction’
         increase the component quantity that was reduced (object dimensions)
         find ‘opposite’ structures relevant to a ‘function application’ (call_count)
         neutralizing
         invalidating
         reversing
         reducing
         find opposite functions
         find function that reduces the excess
         find function that reduces the reduction
         find function that neutralizes/invalidates/reverses/reduces a function.call_count
         this may not be fewer general steps away:
         every problem format change requires:
         checking new problem format for difference from solution format
         finding a conversion function to convert the standardize solution format into the current problem format
         finding a connecting function for the current problem format & the standardized solution format
         every solution format requires:
         standardization (can be done at beginning of interface query)
         but the logic for these steps may be adjacent to create/derive, or it may already exist, so that solution fulfilling the general steps is trivial to assemble with existing logic
         example logic that would already be defined:
         standardize structures
         pull definitions
         find similar structures
         find relevant structures (meaning)
         check for matches in similar structures
         check for usefulness (reduction of solution steps, clarity, or solution) of structures
         other filters can then be applied, like intent (does the format make it more efficient to fulfill a problem-solving intent relevant to the problem)

Apply Structural Interface to Find Connecting Functions
integrate (align & connect) structures of functions on multiple interfaces:
   concept:
      ‘aesthetic’: generating aesthetic functions using simple/balanced/relevant structures, using assumption that aesthetic functions exist to connect variables
   pattern:
      generating formulas based on patterns & anti-patterns of other formulas
   structure:
      using limits that bound other formulas as assumptions to reduce solution space
      finding vertex variables of formulas & applying variations to generate other formulas

Apply Structural & Info Interfaces to Apply Question (Info Imbalance) Structures to Find Answers to Questions
questions have the structure of a possible connection sequence forming a path in the problem system, formatted as a network
the patterns of these questions in producing relevant info for a problem can be used as insight paths
alternatively, apply a general insight path of calculating which paths in the problem network have the sequence of input/output info that could produce the answering info to the query
   formatting the system with structural interface metadata (such as info gaps, intents, incentives, equivalences, & vertex variables) will make these optimal query patterns more obvious
identify the connection between components with the uncertain connection using inputs & definition routes of the connection
   example:
      find connection function: ‘is it object A’ uses the ‘equal’ connecting function
      find inputs: the ‘equal’ connecting function uses the ‘definition’ object as an input
      generate the interface query to solve this problem:
         ‘to determine equality, find the definitions of the objects whose connection is uncertain’
      which can be abstracted into the solution automation workflow insight path:
         find the inputs of the uncertain connection function and apply them to connect the objects with the uncertain connection
   example questions:
      is it object A (the uncertainty is whether ‘it is equal to object A’)
         check definitions of object A & referenced object (it) for equivalence=>if matching, convert to declarative statement with boolean=>yes, it is
      how to connect variables a, b, c with variable d in the direction of variable d (the uncertainty is ‘are a/b/c predictive of variable d’)
         apply change interface to question
         identify change functions applied to variables (or structures of variables) (or their components) that could change variables a/b/c into variable d, or move them to variable d's position
         apply structural interface
         position variables in a variable/function/object network
         convert to structural question:
         can structures of interaction between variables a, b, c, or their attributes/functions/components create variable d
         apply structures (combinations, sequences) of interaction to variables a, b, c & their attributes/functions/components

Apply Structural Definition Routes to Differentiate Similar or Related Concepts
change: sequence of difference structures
difference: non-equivalence on some metric
variable: attribute capturing an isolatable change type

Apply Structural Interface to Find Alternative Filters/Routes & Identifying Optimal Filter/Route Structure, as Well as Optimal Starting Point (Origin), Direction (Target) & Steps (Queries) to Generate them
the below ‘reverse engineering’ example uses the following filter query to determine relevance, reverse-engineering a definition of relevance that can be used to find relevant structures, a definition that is formatted as a set of filters, using a structural definition of relevance (similarity)
   relevance=reverse(similarity=>core=>combine=>not structural alignment=>adjacence)
   relevance=a structural definition of relevance (similarity), with core functions derived, core functions which are used to create function combinations, which can be applied to the original structure to find adjacent structures, filtering out similarities that are one-interface similarities (like structural similarities) rather than relevant similarities (multi-interface similarities)
but it could also use alternate solution filters to find relevant info to the solution such as: (substitute (similarity && quantity) test)
   apply ‘substitute’ structure: find a metric that functions as an identifier, filter, approximator, predictor, or proxy
   apply ‘similarity’ structure to ‘quantity’ attribute: find a metric value for a quantity of more than one unit
   apply ‘test’ structure to problem system structure: find tests with output info containing the metric value
these alternative filter sets optimize for metrics like:
   filter set metadata
   optimizing for different interface metrics (variance degree, interaction layer, abstraction level)
   having a particular structure (paths to connect source/destination) that uses available functions
   maximizing a particular change or difference type for identification/accuracy-related intents
   connecting difference types in different spaces (standardization)
   interface structure-fitting (like ‘intent alignment’ or ‘lack of contradictions’)
these alternative filters have different metadata, like:
   cost
   variation sources (equivalence definition)
   variance reduction (degree, type, pattern, potential)
   requirements (like required info access)
   path (in the filter network, & also possibly a path in the problem structure network)
   interfaces, structures, & definitions used (‘questions’ asked by the query, ‘alternatives’ used as ‘approximations’)

Apply structural interface to identify connecting (consensus) perspective between opposing perspectives
transform a structure in each perspective to a structure in the target perspective
   identify structure of attributes/functions/objects common to both perspectives
      connecting functions like: ‘function connecting power and distribution’, ‘function describing dictatorship dynamics’
   identify interface objects within structures
      change type in connecting function: ‘direction of power distribution’, ‘changes in identity & size of group in power’
   identify similarities in interface objects within structures
      similar change pattern in change type in connecting function: ‘power favoring distribution’, ‘military coups after power abuses’

Apply structural interface to identify an object like ‘contradiction’ (contradiction of a statement, formatted as a route between network nodes)
query for conditions that would convert some input, component, or output of the statement function route into some structure of falsehood (invalid, impossible)
example:
   query for intents that would require movement in different directions than the statement function route requires
   query for causes or preceding/adjacent/interacting functions that would require development of functionality making some step in route impossible

Apply structural interface to structure to generate a particular structure/format (structure standardization)
example of converting structures into vectors
   many vector structures can represent interface structures
   example of selecting a vector structure to represent an interface structure on a particular interface, applying structure to indicate metadata about structures
      example: causal loop
         standard network structure translation: vectors to indicate direction of cause
         relevant network structure translation: vectors of influence degree away from hub cause & other cause structures

Apply structural interface to identify rules that violate a metric
metrics/requirements like:
   ‘dont exacerbate inequalities’
   ‘protect minorities on the disadvantaged side of an inequality’
   ‘identify advantaged side’
power structures: required or non-specific/universal resources (such as inputs to any function, like ‘energy’ or ‘info’)
inequality structures: differences in distribution of required resources
generate structures that would violate a metric (exacerbate inequality structures)
   assumptions in rules (lack of guaranteed potential to follow rule)
      rule ‘close malls after business hours’
         rule structure: ‘limiting supplies’ (access to facility)
         rule assumption: that they have alternative supplies
      rule: ‘fine for not wearing mask’
         rule structure: ‘requiring function’ (purchase mask)
         rule assumption: that they have inputs to a requirement
   these assumptions would disproportionately increase inequality's disadvantages in distribution
      ‘disadvantaging rules/assumptions’ can be distributed more evenly or to offset inequalities

Apply structural & change interfaces to find alternatives (alternate variable sets) in a problem space (exercise) for problem of ‘predicting a change type’ (predicting motion)
apply interfaces to find relevant structures
   exercise variables:
      info (about optimizations, possibilities, rules, metrics)
         attention/memory to focus on, remember & apply info
      patterns
      structures
         point (metric threshold values, change points, decision points)
         sequence:
         combination: multiple variables to make a decision
         limits: time limits, energy limits
         context
         health
         energy
         environment
         landmarks
         agents
         interactions/events
   time
      time structures (alternation, number of seconds, continuity of pattern applied)
   functions
      core functions (test, start/stop, switch, remember, identify)
      interaction level functions (decide when to speed up, plan decision points)
   concepts
      energy
      agency
      intent
         exercise intents: recover, rest, test/find limit, test function, switch energy sources, apply info, identify landmark, align with music
         other intents: what to do after workout, scheduling limits to work around, listen to new music, listen to music limited number of times
apply interface structures (like combination) to relevant interface structures found in problem space (like ‘health’ concept) to generate solution space (possible prediction variable sets)
   alternative variable sets that can predict motion:
      apply filter structures to problem & solution structures like ‘opposite’ (what cant be a solution)
         time cant be used as a base on its own bc usage patterns may offer the illusion of equivalent alternatives that are actually different
         example: pattern ‘a-b-c’ may occur just as often as ‘a-b-d’ without any distinguishable signals using available time info, so other interfaces need to be applied to predict c or d, such as contextual/intent probabilities, or patterns like intent patterns or change patterns
   agency rules
      agents have known intents, which interact in a known way
   interaction rules
      energy, time, agents, & health interact in this way
   energy rules
      ‘energy can be used to produce energy in other formats’
      ‘stored energy can replace agent prioritization’
      ‘excess energy can have these outputs when used optimally’
      ‘energy efficiency increases with usage’
      ‘high variation in usage increases energy coordination & distribution’
      ‘brain & muscle energy are related, in a pseudo-tradeoff’
      ‘high variation in energy usage can offset energy plateaus’
   variable interaction patterns
      ‘using n number of variables to make a decision only occurs once out of every x decisions’
      ‘applying previously applied variable interaction rules is most common’
      ‘excess energy results in higher variability of variable interactions’
   concepts
      concepts & concept structures (concept set including ‘energy’ or ‘health’) can predict independently of other variables bc theyre a low-dimensional (conceptual dimension) representation of high variation (motion)

Apply Structural Interface to Solve an Info Problem
apply point structure: find examples
apply set structure: find combinations
apply boundary structure: find limits (systems, shapes, expectations)
apply gap structure: find possibilities (opportunities)
apply sequence structure: find paths
   apply input structure: find assumptions (requirements)
   apply output structure: find intent (side effects)
   apply function structure: find connections (cause)
apply origin structure: find symmetries (equivalence)
apply vector structure: find differences (comparisons, opposites, errors, distortions/imbalances)
   identify vertexes & transform input info to vectors for each vertex
   identify interfaces & primary interface objects & transform input to vectors for each vertex
   apply queries across vector spaces to find patterns of change that produce solutions optimally (quickest or most accurately)
   integrated info format for formatting vectors across vector spaces representing differences within an interface/vertex variable
   space1.vectorA (magnitudeA, directionA)=space1.basis vector coefficient combination spaces.space1.vectorA=spacevector.vectorA=vector differenting from other spaces [space coefficient combination].[vector coefficient combination][space topology position].[vector topology position]
   in this format, you store info about the original vector with its relative position to other vectors given the basis vectors of that space, and info about the original space with its relative position to other spaces
      each space offers a relative position for differences in an interface
      given the set of vectors mapped within each space, the vertex vectors of the original differentiating vectors can be mapped as the vector space instead
   alternative vector formats/variables
      vector paths: store method to generate a particular vector
      vector boundaries: store info about vectors with similar interaction layers (like ‘interacting with a sphere of radius 1’)
      vector gaps: store info about a space lacking vectors in a vector space
      vector bases (core sets): store info about alternate basis vector sets describing a vector space according to different bases of change units
      vector shapes: shapes formed by vectors (points, polygons, shapes, corners, angles, centers, intersections)
the vectors may be more efficiently described in one format than another, within or across spaces
   to integrate the vector spaces that have had these formats applied, you can:
      maintain the original space and describe the vector variables with the new vertex vector sets
      create new vector spaces to map the differences in that variable
   if the differences dont hold across every vector space, you can:
      calculate the contribution of that space in another space where it would contribute to those difference types (apply elements in a biological space)
      find a space where both the non-contributing vector space and the contributing vector space can be differentiated & calculate it there (genes & elements in an evolutionary space)
example of mapping math to meaning formats
   structural math info formats according to intent to calculate semantic operations (solve info problems)
      add to shape definition routes with matching intents supported by each
         adjacent intents use the objects directly stated in the definition route:
         endpoint alignment
         adjacent intents associated with this format:
         use endpoints & rotation/shifting transforms to build a shape
         complete a shape using a line and an ‘align endpoint’ function
         store just endpoint & alignment info
         use an angle determining function to provide input to an alignment function
         keep coordinate info intact after transform
         track changes within space using endpoint/line coordinate changes
         use core structure (line, angle) as a building block
         coordinates of one corner & side length
         side count & angle
         these intents can be mapped to meaning
         “align endpoints”=“connect” (such as in the case of “connect a line to a shape missing one line to be completed”)
         once mapped to meaning, it is clearer how these structures can be used to calculate other metrics
         in the “connect a line with a shape to complete a shape” case, its good if we already stored info as coordinates & lines, bc then we can adjacently pick a line & place it in the right position to complete the shape, by aligning coordinates of endpoints
         this structure can be applied to info problems
         testing for obviousness of an argument:
         ‘obvious’ math structure definition route:
         adjacent change:
         if an argument can be made by connecting a line to complete a shape, that's an “adjacent” change, and it can be considered obvious using this math structural definition route
         forming a square with two triangles is an ‘obvious’ way to make an argument that ‘two triangles are equal to a square’
         example of formatting an argument as a shape
         a, b, c, d are points on a square, starting from top left and going clockwise
         line structure: change operation
         side length: degree of difference
         side line: change type with direction from starting point to end point
         connection: direct relevance
         change type: straight line, constant, tangent, border, etc
         right angle/parallel: independence/dependence (difference/similarity in change type)
         ad is similar to ab by starting position, but different by independence (in change type & direction)
         ad is different from bc by starting/ending positions, but have similar change type & degree, and are connected in two ways by one degree
         inevitable conclusions map adjacently to filters with one possible output structure indicating the relationship of the conclusion objects
         logical conclusions are buildable from other logical conclusions or insights (known connections) with accessible transform operations applied
         function: link nodes in a network (‘connecting the dots’)
         another example, in reverse (meaning to math)
         relevance:
         info that fits in a system (connects coordinating inputs/outputs, changes on system variables, has an intent position/function in the system, doesnt contradict system intents)
         info that is useful for a defined/structured input intent or output impact at x degrees away from input
         implied in this definition, specifically the ‘defined’ part, where the structure of the input intent definition determines what can fit it, is the concept of ‘focus’, which has a ‘filter’ structure, meaning only some info will be relevant to the input intent, and other info needs to have the filter definition structure applied
         so an implementation of a relevance testing function will incorporate a filter structure or an equivalent substitute

Apply Interface Analysis to Find Optimizability of a Problem, Given Resource Limits (Market, Time, Info about Alternative, Related, & Interactive Products)
problem of finding optimizability in the form of a solvability limit of a problem, without knowing the answer
   example: standard ‘psychic’ magic trick like guessing number of fingers held behind back, or which number people will choose
      connected structural info:
         when they choose the number
         physical motion rules
         how arms/joints move
         how their eyes move (indicating remembering or creative process or a local distraction or another input)
         default input rules
         hand motion dynamics, like how fingers interact & which motion types are favored/prioritized/likelier
      general rules
         alternative selection rules
         how people make decisions from a set of similar alternatives (familiarity, understandability, simplicity, standard vs. non-standard choices)
         intent rules
         agent intents (trying to surprise the magician by subverting expectations of their choice)
      related variables
         attention
   limits of solvability occur with non-interchangeable (not equal) alternatives that can't be distinguished with the given info, without being given the info of the answer (or info that makes it identifiable or possible to filter/reduce other options)
      indicates that the interaction of the available variable info:
         is too low-dimensional
         includes info about too distant/indirect variables/rules
         includes info that cant capture/derive approximations/actual values of the variation/patterns of the output variable or its proxy variable
         doesnt have a vertex variable or connectable interfaces/variables
      there may be some combination of movement, rule selection, default config, attention & memory that produces difference choices without giving clear info signaling this difference (limit of solvability is reached)
problem of finding optimizability of ‘buttons vs. configuration’ problem (headphones with buttons)
   variables
      hardware
      alternative/related/interactive products
      usage patterns
      sound functions (play, skip, switch to voice commands, reduce noise, highlight bass, use more capacity to clarify sound quality, change relative volume, predict lost sound)
      buttons
      attachability/detachability/migratability
      compartmentalization/isolatability
      buildability
      configuration options
      simplicity
      memorizability
      adaptability
      app
      higher-variation alternative interfaces
         sound input/output (alternative input to a button)
      probability (commonness of a usage pattern)
      demand (need for a button, configuration, usage pattern, or a function)
      variable structures (combination of variables, like a particular set of variables or a set of interaction rules between variables)
   implementations
      find common usage patterns & assign to buttons
         buttons for common functions
      find memorable button structures & assign to common usage functions
         find memorable combinations & sequences, like double-click of a button, or a button combination click, and assign to common usage functions
      inject crucial high-variation function in higher-variation interface
         configurable button functions (configure options of how buttons connect to functions), using an app (higher-variation interface, allowing more buttons)
      inject crucial high-variation function into a button
         configuration button (configure options of how buttons connect to functions), by clicking a config button
      embedded menus in buttons
         access menu (list of functions) with a button or button structure (combination, sequence)
      alternate input with higher-variation potential
         voice commands rather than or in combination with buttons
      allow buttons to be attached like legos
      allow buttons/functions to be coded & switched out to do any function the hardware (or connected hardware) can support, including functions from other alternative products
      integrate with existing hardware like glasses/hat/shirt (use materials to conduct sound, attach speakers/microphones to glasses rather than having wires, attach buttons to glasses)
      allow each alternative to be selected so they can choose which config/button/sound interaction rules to apply to those variables
   optimized mathematized implementation for intent (simplicity, highest features given simplicity, maximized features)
      simplicity: assign common (high-probability) functions to buttons & simple button structures (low-dimensional buttons & button structures)
      variables: button count, button function, button structure (combination, set, sequence), function probability, simplicity
      highest feature count, given filter of ‘simplest implementation’: highest number of functions possible to implement simply (low-dimensional memorization)
         variables: function count, memorization, simplicity, abstraction (type), button usage structure (scale like repeated clicks of a button, sequence like buttons clicked in sequence)
         variable interaction rules:
         ‘when function count increases absolutely (all other variables being equal), memorization decreases’
         ‘when count increases but is organized simply (like accessing functions organized by type or scale with successive button clicks), memorization is constant’
         variable structure:
         intersection of independent variable changes (function count & memorization)
         alignment of simplicity & memorization changes
         alignment of abstraction (type) & simplicity changes
         substitution of proxy variables (substitute more measurable variable like simplicity for memorizability)
         substitution of more measurable variables
         substitute simplicity-filtering rules to identify complexity rather than using complexity identification rules
         substitute similarity-filtering rules (what something is) to identify similarity than difference identification rules (what something is not)
      optimized variable structure:
         maximized
         parameterization of variables that change on similar input
         intersection of variables to optimize (intersection of highest function count and highest simplicity)
         alignment of related variables (aligning memorizability & simplicity) that should be similar
         opposition of variables that should be different
         compression/merging/selection of variables that act interchangeably
         structure application
         sequence structure applied to causative variation (input/output)
         topology structure applied where changes in variable values of a variable set can be mapped to distance (different changes do not produce equal points)
      maximized features: use highest-variation interface as input to generate temporary/editable config (app configuring which implementation to apply, which custom functions to use, which hardware to combine when ordering/updating)
         variables: config input (voice, button), variable variation, config adaptability, config source (custom user-defined function, open source/multi-vendor libraries)
      how to generate optimized mathematized implementations for intents
         apply structural definitions of components (rules, variables, intents, concepts)
         find interface where these structural definitions of components can be depicted according to their variation (dimensionality), interactions (substitutability, causation), & metadata (accuracy)
         interface where variable structures (constant, sequence, input) and function structures (interactions/alignments) can be found & connected as needed
         identify interaction structures (like trade-offs) between optimization metrics
         find maximization of metric-optimization in those interaction structures

Apply Interface Analysis to Find Alternative Solutions for Matrix Multiplication Problem
existing solution (apply multiplication method to smaller matrices) applies:
   core structures:
      meta (matrix of matrices)
      subset (sub-matrices)
      substitute (addition for multiplication)
   core functions:
      apply substitution method to subset once matrix is formatted as a matrix of matrices=apply(substitution_method(format(original_matrix, ‘subset’)))
how to generate other solutions
   multiple queries to arrive at the same solution of ‘finding adjacent interim values & reusing multiplication operation, in case where adjacent interim values exist in a matrix’
      you can start with the target solution formats as your interface query filter (equating “problem format+operations=solution format”)
         a more efficient operation than multiply
         a more efficient combination of operationss than ‘multiply then add’
      or you can start with applying interfaces, and iteratively focusing on & applying useful structures found for the solution (problem-reduction or problem-compartmentalization)
         apply structures known to generate solutions to fulfill solution metrics (move toward solution position or reduce solution space or reduce problem)
         apply core/adjacent/efficient/similar structures
      apply structural interface
         apply core structures of structural interface
         apply structural similarity to structures of problem (including value)
         similar values enable addition instead of multiplication (multiply 5*8 & subtract/add 8 instead of multiply 4*8 and 6*8)
         if there are similar values in a matrix, and storage is allowed, this can reduce multiplication count (ignoring storage search)
         apply adjacence structures
         find values adjacent to matrix values to find similarities in computation requirements
         apply similarity structures
         find values in matrix having a common factor (base) and standardize operations involving those values
         apply sequence structures
         find sequences in multiplication operations & apply sequence operations rather than individual calculations
         find numbers in even number sequence (common factor of 2) and reduce to addition of coefficients of powers of two
         3*5+2*6+2*4=3*5+2*2*3+2*2*2=3*5+3(2\hat{ }2)+2(2\hat{ }2)=3*5+5 (2\hat{ }2)
      apply function interface
         find functions that convert multiplication to addition or other lower-cost problem
         replace/substitute
         identify when multiplication can be replaced by addition
         addition can replace a multiplication, if an adjacent multiplication has already been done
         convert numbers to efficient multipliers like powers of 10 that involve moving digits rather than multiplication
      apply core interface
         apply core functions (replace) & core structures (unit) to problem components (problem functions of multiply & add)
         apply interface interface (standardize problem to interfaces of problem space)
         apply system interface
         apply system structures
         apply efficiency structures
         identify efficiency structures in problem
         inefficient operation (multiply)
         efficient operation (add)
         apply change interface
         connect an inefficient function (multiply) to an efficient function (add) to change inefficient function to efficient function
         define one problem function as a transformation of the other problem function
         define multiply in terms of add using core functions/structures or problem functions/structures
         apply replace to one unit of original multiplied values with an add operation until multiply is defined in terms of add (standardize to add interface)
         apply efficiency structures
         apply efficiency structure ‘apply one operation instead of multiple operations’
         identify when multiple multiply operations can be replaced with this type of adjacent multiply/add operation
         identify when a multiplication operation can produce an interim value in between other values so the multiplication can be re-used for another value
         apply structure interface
         apply structural interface structures
         apply filter structure
         identify matrix cases where these operations are inefficient or unusable
         identify operations/info needed to determine inefficiency/unusability of this solution
         apply function to determine threshold value for matrix dimensions or metadata like value variability (if values are in a known range or have a known type):
         ‘if there are more than x adjacent values with an interim value in a matrix of size n×n, this method can save computation steps even with the determining operation’
         add average cost of determining operation to cost metric (computational complexity)
         apply system interface
         apply system structures
         apply efficiency structures
         apply efficiency structure of ‘reusing existing resources’
         identify what resources exist or are created in original solution (values output by multiplication & addition operations)
         identify condition where these can be reused for other operations
         when other operations are adjacent
         apply symmetry structures
         apply symmetry structure of ‘interim value one change unit away from multiple values
one being addable in the position of a coefficient’

Apply Interface Analysis to Connect Problem & Solution Formats with Interface Query Functions (Including Applying Insight Paths)
source problem input & target solution output formats
   simplicity/complexity:
      identify structures where each perspective would be applied incorrectly & produce errors
         apply core structures (direction)
         apply core structures (angle) to relevant core interface objects (intent) to produce relevant interface objects (priority)
         apply core interface function structures (change)
         error type: priority distortion
         identify error type (over-prioritization) structure
         apply priority list
         identify over-prioritization (over-simplification) error structure:
         apply structure search filter
         what structures are relevant (meaning ‘direct or useful’ like ‘input/output’) to an over-simplification error
         inputs/outputs (including requests, usage, side effects)
         ‘repetition of problem-solving requests or identifying/receiving problem side effect info’
         ‘identifying/receiving over-simplified solution side effect info’
   positive/negative:
      specific insights to convert between conceptual structures
         apply concept interface
         definition of positive/negative includes concept of ‘opposite’
         for intent ‘switch from positive to negative structures’, apply ‘opposite’ structures where change can occur (variables)
         list variables
         charge
         event
         perspective
         context
         list opposite structures of a variable value
         switch to value on other extreme
         switch to value at origin/average
         switch to multiple values
         apply structural interface to multiple values (set, network, sequence)
         apply opposite structures to variables
         intent: subvert expectations by changing attribute to opposite value
         change metadata (name) of something good to metadata (name) of something bad
         intent: highlight good events
         change something good to something bad
         intent: identify melodramatic attribute of negative perspective
         reduce metadata (size) of something bad
         increase metadata (size) of something bad
         compare to something extremely worse, as being the worse thing
applied insight paths
   ‘all structures can be linked to all structures’
      ‘similarity is similar to difference’
      ‘structure-linking becomes likelier with previous structure-linking’
         ‘connecting negative & positive structures is lower-cost with each iteration/application of the connection function’
         ‘extra resources are lower-cost with a positive-negative connection structure (like a function to convert between negative/positive perspectives)’
      ‘opposite & equal (apply discrete not structure) are lower-cost to connect than different & similar (apply continuous scale structure)’
         ‘positive and negative are examples of extreme structures and opposite structures’
         ‘positive and negative are opposite extreme values of a spectrum structure’
         ‘positive and negative are inherently connected’
         ‘connecting the extreme positive value with the extreme negative value is often lower-cost (multiplication by integer of −1 with center at integer of 0) than connecting most interim values with extreme values (determine sequential difference in fraction digits, and use addition)’
   ‘outward extreme negativity error implies a direct causative error structure of either an (internal extreme negativity error) or (minor negativity error, at extreme scale)’
      ‘the error structure can be lack of power distribution (power in the form of intelligence) or lack of distributed generative inputs of power (help becoming intelligent)’
         ‘an invalidation request error is structurally adjacent to a negative-positive connection structure request error, bc the negative-positive request occurs with a prior powerful invalidation request directed at the powerless requester’
         example: ‘weak person trying to destroy a powerful person indicates lack of ability to become powerful, so the weak person requests help to connect their current negative state with the positive state bc they cant build the structure connecting those states due to lack of power (lack of intelligence or proxies to intelligence like info)’
         ‘an invalidation request error can be solved with distribution of a negative-positive connection structure’
   ‘structures have variables, like size, position, connection, intent, cause, and potential for error’
      ‘errors are a type of structure’
         ‘errors are not definitively a negativity structure’
         ‘errors can be positivity structures, depending on the error variables (like cost vs. potential created by error solution or solution process)’
         ‘errors have structural variables (position/direction)’
         ‘error outputs sometimes include measurable info, indicating the structural variables (position/direction) of the error’
         ‘measured error info can lead to organization of resources in the direction of the error’
         ‘organization can be a causative factor in generating solutions’
      ‘error structure types include errors in structure variables (like direction/degree)’
         ‘errors of extremity are often directly due to extremity of directed force (error of priority)—or indirectly due to lack of organization/adjacence to correct errors, lack of previous solutions, lack of previous direction/degree-correcting solutions, lack of previous errors, lack of previous direction/degree errors’
         ‘negativity errors are often due to over-simplification’
         ‘over-simplification is similar to over-reduction & over-isolation’
         ‘apply opposite structures (like reversal) to resolve an error’
         ‘applying reversal to reduction & isolation can resolve an over-simplification negativity error’
         ‘reduce the lack of negative-positive connection structures, by distributing it to all error sources’
         ‘input of negativity errors is a lack of solutions and direct output may include new error info’
         ‘negativity errors are a useful mechanism to allocate extra resources to find new error types & correct them’
         ‘alternate sources of new error type info is error-type generation function using vertex or interface (core/common/causative) components, to identify where errors can occur or would be invalidating in a system’
insight paths inside applied insight paths
   the following similarities in structures of difference provide quick alternate methods of deriving the solution structure for an error structure, bc they represent standard formats in common
      an error of extremes of power distribution in positions (weak vs. powerful position) can also be used to infer the solution structure component of a negative-positive connection structure
         variation in identity:
         weak-powerful::connected by opposite extreme
         negative-positive::conncted by opposite extreme
         similarity in structure
         weak/powerful::negative/positive::extreme/opposite extreme
         opposites exist on a spectrum
         spectrum extremes are connected by similarity to average & conversion potential
         connecting function
         connection by position
         negative/weak::lack
         positive/powerful::excess
         lack & excess are error type structures (implying an associated solution)
         negative & positive are both differences from average
         connection to average resolves ‘lack’ and ‘excess’ error type structures
         *** alternate insight path: errors of extreme values in a variable imply a lack of a balancing (solution) structure like:
         an extreme-connecting structure
         a direction/degree-correcting structure
         an error-detection structure like a low-level error threshold
         error structures of extremity, reduction & isolation can also be used to infer the solution structure function of a reversal applied to extremity/reduction/isolation structures
         variation in priority/direction
         over-simplification::reduction/isolation
         over-complication::expansion/integration
         similarity between over-simplification & over-complication
         over-simplification::opposite of over-complication
         connecting function:
         opposite::reverse
         apply ‘reverse’ structure to correct ‘direction/degree’ error
         an error structure produced by a sequence implies a solution structure in the form of an opposing operation relevant to sequence (like reversal)
         an over-reduction/isolation error structure can be used to infer a solution structure of a ‘connecting & expanding’ or ‘averaging/balancing’ function

Apply interface analysis to neural networks (core functions, interaction layers, etc) to generate different organization structures as components of a new neural network type
examples of interface structures relevant to neural network structures
   interface interface (relevance/usefulness)
      organization structures represent applied concepts & structures like balance, functions/attributes like relevance/security, error type boundaries, abstraction levels, etc
   core & structure interfaces:
      combine core operations (rotate, connect, combine, shift, filter) to convert the base subset/limit functions building or used by a neural network into the output prediction function
   intent interface:
      a granular intent structure like “differentiate=>maximize=>combine=>compare=>select” can map to a high-level intent like “voting”
these structural equivalences/similarities across interaction layers (like different abstraction levels of intents) can be used to implement concepts like ‘security’ to neural networks, such as identifiable/possible error type structures as a boundary/limit (in the form of a threshold or weight-offsetting operation) across a metric calculated from an adjacent-node cross-layer sub-network (like ‘function sequence’ structures are often used in exploits)
apply structural interface to core structures to generate conceptual structures in neural networks
   variables of the network include structures emerging from or embedded in algorithms/structures
   core structures
      change types
         difference type
      agency types
      cause types (influence/power of structures)
      structures
         sequence (embedded concept of ‘time’ in structural interface)
         list (unique index)
   alternative cause: change applied to causal structures at training & prediction time
   organization: difference type index
   agency/govt: decisions about change types to apply
      structures applied to agency objects like decisions (such as subsets/alternates) & other conceptual structures (like time)
         sub-decisions
         structures of neural networks with delayed sub-decisions
         conditionally activated cell structures with enough info to make a sub-decision
         structures applied to decisions can generate networks with other decision structures than ‘consensus voting’
         govt structures/algorithms
         organization structures are a structural version of govt (agent-based) decision-making
         finding the level of ‘agency’ to apply to a network is possible with problem complexity identification
         apply agency: delegating decisions to subsets/groups/layers of cells to delay change decisions to another point in time
         alternative decisions to make in interface query
         decisions are a ‘selection/identification/filtering’ problem about a possible change type (like direction) to consider/implement
         structures of neural networks exploring alternative variable structures & alternate decisions rather than the stated problem decision or default variable structure (identify direct causation, filter out non-directly causative variables)
         alternative decisions
         finding root cause
         solving a proxy problem
         decision (change-filtering problem-solving) times
         standard time points: training time, data gathering/processing/standardization time, decision/prediction time, re-training/update time, parameter selection/update time
         sub time points: activation time, pooling time, aggregation time, filtering time
         optional points where decisions can be injected
         decisions:
         network-level decisions: continue learning, select prediction answer
         structural decisions: change direction, identify threshold, ignore info
         meta decisions: delegate/delay decisions, consider alternative decisions
         time where decision is clear/final/starts to emerge
         time where direction change decision is made
         time where more info/time is identified as necessary
         time where decision is identified as not answerable
         time where alternatives are identified, assigned probability, filtered out
         time where possible routes to an answer are identified (what structure of variable values like ‘ranges’ can produce a clear answer)
         time where possible decisions remaining are identified (and conditional remaining decisions if a change is applied)
         time to check for a structure in the difference type index

Apply Solution Automation Insight Paths to Solve Problem of ‘Find Connecting Function Between Math-Language to Generate a Math-Language Map’
apply core structures like ‘opposite’ to interface components to generate a language map
   opposite structure of interface (division by applying a standard) is an application/combination (multiplication by creating combinations of pairs, of one variable's range applied to another's)
apply connecting function of math-logic (logic being an interim interface of math & language)
   a problem like the following is a logic problem (‘find the logic connecting this input/output’) that can respond to the general solution workflow (given a problem input format of a ‘function’ to check possible solutions with) of:
      ‘identify the unique correct solution in a solution set to a problem of equalizing the sides of this function’
      ‘identify which solutions are not correct, reducing the set to a size of 1’
      this can be converted to a math problem of:
         iterating through solutions
         checking each solution to see if it solves the problem (‘equalizing both sides of a function’)
         removing it from the solution set if not
         otherwise checking if the set of possible remaining solutions has a size of 1 yet to give a success signal
         continuing iteration if not
      the connection between these interfaces is in the structure of logic (math being structural info in core terms like numbers):
         the set iteration has a ‘sequence’ (set, progression) structure
         the remaining solution set size has a ‘integer’ (set, progression) structure
         the success signal & the continuation condition has a ‘0/1’ (core alternative) structure
         the solution test has a ‘function’ and ‘equal’ structure (are both sides equal yet)
         the remove operation has a ‘subtraction’ structure
         the continue operation has a ‘sequence’ structure
         the condition component has a ‘direction’ structure (change direction in logic network/tree) and ‘multiple option’ structure (a decision between differing & mutually exclusive options must be made)
         the check/test operation has an ‘equal’ & ‘inject’ structure (inject variable values to see if both sides are equal)
         the logic function has a ‘directed network’ or ‘tree’ structure (follow directed relationships between function components)
      apply structural interface to connect logic & math structures:
         1. some of those structures have structural relationships which should be identified by applying interfaces, like structure (including components like the similarity concept)
         similarity:
         the similarity in structure between the solution set size & set iteration (a progression or sequence) is relevant, bc the iteration & the set size should:
         move in opposite directions
         equal the original set size when added
         by applying the structural interface (with components like the concept of ‘similarity’), the query can identify this relevance by checking if an adjacent connecting function between the similar structures exists & is relevant to the problem/solution
         generate core functions & generate combinations of them, applying them to problem variables being examined for a connecting function (solution set size & set iteration)
         filter by those applied core function combinations that move/change the problem (converted into a solution space, once identified) to be more similar or closer to the solution structure (solution set of size 1)
         direction:
         given the sequence & other direction-related components/attributes/structures of the problem, the input problem components & output solution structures can have a position structure applied
         2. given that the solution format is a ‘set of size 1’, and the input problem format is a ‘set of size greater than 1’, it can be derived that:
         when executing problem-solving method, the method should include a step where:
         an item(s) is removed from the set
         this connecting function between problem & solution format derives the solution requirement of the ‘remove’ operation (without being explicitly told to include that operation in the problem definition)
         given the other structures involved (integers, iteration sequence), it can also be derived that the remove operation should apply a subtraction operation rather than another structure like division, which would introduce other less relevant & adjacent formats like non-integers
         this applies problem-solving insight paths like ‘adjacent solutions should be tested first in an absence of reasons to do otherwise’, where reasons to do otherwise could be metrics like system complexity, info about adjacent solutions failing in that system, info about non-adjacent solutions succeeding in that system (info about non-adjacent solutions being optimal for a system metric)
         interface query design should involve queries to check for inputs to a step given required sub-query tests for alternatives
         before applying a step, apply its required sub-queries to test for its alternatives, like for an adjacent solution step, checking that alternative non-adjacent solution sub-queries have returned no contradictory info indicating an adjacent solution should not be applied

Apply insight path to solve problem of ‘find correct structure (sequence/position) for components’
insight path:
   when generating solutions, identify:
      contexts/cases/conditions that can filter it out
      variables that can generate the most solutions
      filters that can filter the most solutions
         apply filters to solution space by solutions that are ruled out in fewest cases, best cases where solutions are less required or least probable cases
example problem: how to put shirt on underneath jacket without taking off jacket completely
   alternative queries
      identify sub-problem:
         find a format where sequence (shirt on top of jacket) can be changed into solution format (jacket on top of shirt)
         identify adjacent format ‘bunching into circle around neck’ that allows changing sequence (which is on top) and transformation function into that format from origin format ‘taking off sleeves’
      apply adjacent formats to problem & solution formats
         identify formats that have a sequence (stack, row) which is a structure implied in the solution format (‘underneath’)
         apply functions to test if shirt can be transformed into one of those formats
      generate adjacent functions (bunching) from core functions (move sleeve, lift, rotate) & try them to see if any useful structures emerge moving objects closer to solution formats/positions
      generate default connecting function and apply structures of optimization (reusing functions, avoiding extra steps) to improve the default connecting function incrementally
      identify filters that can filter out solutions
         identify filters interacting with structures of variables (change types, potential, uncertainty) & constants (requirements, limits, definitions)
         possibility filter:
         interaction filter:
         in what ways can the shirt/jacket interact
         can the shirt occupy position (fit) under the jacket
         requirement filter:
         does the shirt/jacket have to stay in its current position/format
         does every step of functions (‘removal’ function) have to be executed (can you just remove pieces, like the sleeves, without removing the whole thing)
         change filter:
         in what ways can the shirt/jacket be changed while remaining a shirt/jacket (bunching, removing sleeves)
         are these ways reversible (can it be put on after being taken off)
         apply filters to reduce solution space
         solution can involve variables:
         position
         format
         change functions (bunch, lift, remove)
         components (sleeve)
         interaction functions (stack in sequence)
         solution must fulfill requirements
         jacket must be in ‘worn’ position at all states
         change functions cant change object identities (change jacket into shirt or into a not-jacket)
         solution must reverse sequence of objects in stack structure)
         any solution involving removing the jacket completely in a state, change functions that change object identities, and where solution format is not fulfilled are ruled out
         other tests include:
         minimize steps (did solution do any unnecessary steps)

Apply Insight Path to Solve Problem of ‘Find Factors to Produce Number without Using Multiplication of Every Combination’
insight path: use filters to reduce solution space instead of generating solutions (such as by identifying metadata of solutions & applying combinations of those attributes)
problem: find factors of 28 without using multiplication of every combination (trial & error)
   factors of 28: 1, 2, 4, 7, 14, 28
   remove: 1, 2, 14
      divide by integer unit 1, divide by 2 bc even, divide by co-factor of 2 which is half (select midpoint without multiplication))
   the remaining candidates are: 3, 4, 5, 6, 7, 8, 9, 10, 11, 12, 13
   apply filters to solution space
      apply similarity of value structures as a filter
         adjacent items can be ruled out by proximity (for example, 13 couldnt be a candidate bc its too close to 14 to be a factor of such a small number)
         the remaining candidates are: 3, 4, 5, 6, 7, 8, 9, 10, 11, 12
         apply similarity (of adding factors to sequence) as a filter
         test sequences for adjacent computations
         apply similarity of components (factors) in definitions (numbers definable in terms of their factors) to find relevant structures
         test primes which are relevant bc of their definition being definable in terms of the factor standard
         apply output patterns as a filter:
         multiples of 10 and 5 can be ruled out bc it doesnt end in zero or 5
         the remaining candidates are: 3, 4, 6, 7, 8, 9, 11, 12
         apply combination structure to produce solution format (multiplied pairs of factors)
         pairs are a combination structure
         the remaining factors can form pairs, which can also have filters applied
         apply filters to pairs
         apply output requirements
         metadata of the output, 28, includes that its an even number, so multiplied pairs must produce an even number
         odd number x even number can produce an even number
         3×4, 3×6, 3×8, etc
         even number x even number can produce even number
         4×4, 4×6, 4×8, etc
         apply reduction tests (what could not be the solution)
         apply tests to inputs
         inputs must be spaced according to the output number
         adjacent numbers are unlikely to produce the output number (as a multiplied pair) for an increasing output number
         structures of inequality (not equal to solution)
         too large
         too small
         not even
         identify threshold structures (values) of input structures (values, value pairs) that would produce one of these inequalities
         filter out inputs if they would produce an output that was too large to be 28
         28 is quite a small number so pairs of numbers above a threshold value (3× anything above 9, etc)
         some pairs are clearly too big to produce 28, without checking the product
         11×12 is clearly too big, so can be removed from list of possible pairs

Apply insight paths to find & apply cross-interface non-standard methods across systems to generate solutions
apply insight path: ‘identify similar interface components (like concepts/structures) in other systems & solutions used to solve relevant problems in those systems, then convert & apply solutions from similar interface components to solve the problem in the original system’
   apply concepts of agency like ‘bias’ to fulfill intent of ‘creating a truth filter’ in non-agent systems
      bias is usually used to evaluate intentions of agents when interacting with other agents with some level of variance in agent identities
      after abstracting intentions as decision/function triggers:
         apply bias as a truth filter to determine non-agent change/function triggers
         this can work bc even components without agency respond to incentives bc of their common tie to physics, and agents are likelier to identify optimal structures
         example: bias can have a core error structure like ‘over-prioritizing locality’, which can be converted into the concept of ‘adjacence’ as a core structure to use when solving the bias-causing problems of ‘minimizing cost’ or ‘limited info’, or when identifying structures that can be used as truth filters, which can be formatted as ‘low-cost or otherwise adjacent distortions are likelier to be false info’
         bias also interacts with the concept of randomness & randomness can explain false info signals, which connects to the problem-solving intent of identifying truth
queries to generate insight path to find useful structures to apply across systems, for a general problem-solving intent like ‘truth filtering’
   apply solution automation workflow insight path: ‘apply insight paths to generate insight paths to solve a problem’
      apply insight path: find structures for the same intent in other systems, connect structures between systems, & apply matching structures to original system
         find structures with ‘truth filtering’ intent in solution (source) system
         map system components across systems (map ‘truth’ in agent system to ‘correct’ in non-agent system, match ‘intent’ to ‘incentive’ bc non-agent systems always respond to incentives)
         map connecting structures in source system to connecting structures in target system (what connects bias function in source system vs. corresponding connection in target system)
         apply components of structures with ‘truth filtering’ intent across systems, to equalize problem (target) & solution (source) systems
         apply metadata of ‘truth-filtering’ structures (bias) from agent source system to non-agent target system
         apply bias/interface metadata (intent) to target system components
         find intent (‘reasons’) for ‘randomness’ (find the change interactions producing false or temporary randomness in non-agent systems)
         apply bias interface objects (intents/reasons to use biased rules) to target system components, due to commonness in intents across systems
         bias intents/reasons: over-simplicity, lack of storage, lack of change type functions (update functionality)
         ‘if an info signal has bias intent signals (if its clearly caused by lack of storage), classify it as a potential false info signal (request from pathogen rather than from host cell, false electrical signal, illusion of an electron count)’
   apply standard interface query
      apply structural interface
         identify connections between structures in problem
         problem: ‘find true info in agent-based system interactions despite agent incentives to send false info & intentions/decisions to do so’
         problem structures:
         concepts: ‘truth’ (intention matches decision output=‘successful decision’), ‘agency’, ‘incentive’, ‘intent’, ‘decision’
         functions: ‘interaction functions’, ‘decision functions’
         other structures: ‘decision function triggers’, ‘false info’, ‘true info’
      apply combine function to conceptual interface
         create combinations of abstracted versions of structures
         problem: ‘find true info in system interactions despite incentives to send false info & other sources of false info & change functions enabling that’
         problem structures:
         concepts: ‘correct’ (info implication matches its impact), ‘incentive’, ‘change’, ‘randomness’
         functions: ‘interaction functions’, ‘change functions’
         other structures: ‘change function triggers’, ‘false info’, ‘true info’
      apply connect function to abstract structures
         find structures that connect abstract structures (randomness, false info, change/function triggers) without the specific attributes tying them to one system (agency)
         test whether the connecting structures fit with the new system after removing attributes:
         can bias be used to filter out false info or find true info in chemical interactions, despite elements not having agency, as an abstracted way to decompose randomness/noise or complex systems
         for example, can an abstracted version of bias structures correctly model the integration of quantum physics with chemistry rules to explain some chemical phenomenon

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method comprising:
definition routes
problem/solution structures
solution filter structures (like metrics, tests, conditions) to filter solution sets, or specify/adapt/refine/test solutions
insight paths (including solution automation workflows, which are insight paths that connect problem/solution formats)
functions to generate solution automation workflow insight paths
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’).

2. The method of claim 1, wherein example implementations of definition routes of a component may format the component on various interfaces or in various formats that are useful for predicting that component's interactions/outputs, like change conditions & coordination with other components.

3. The method of claim 1, wherein example implementations of problem/solution structures may make connecting functions trivial to find/generate/derive. Example implementations of problem/solution structures may be structurally similar in a way that is trivial to connect, such as:
randomness problem format & organization solution format
conflicting direction problem format & aligning re-routing solution format
reduction problem format & expansion/standardization solution format
lack problem format & generative efficiency solution format
identify problem format & uniqueness solution format.

4. The method of claim 1, wherein example implementations of solution filter structures (like metrics, tests, conditions) can be used to filter solution sets or specify/adapt/refine/test a solution.

5. The method of claim 1, wherein example implementations of insight paths can be used to identify relevant problem/solution structures (like connections between variables) & exclude relevant problem/solution structures more optimally.

6. The method of claim 1, wherein example implementations of functions generating solution automation workflow insight paths (which connect problem/solution formats) may include permutations of structures of problem/solution components like variables/structures (such as formats, component/adjacent/proxy structures, origin/target position/state, connecting functions, definitions, workflows, attributes like complexity, etc).

7. The method of claim 1, wherein example implementations of query-building logic may include logic to select an interface to traverse, selecting multiple interface queries to execute in parallel, & organizing interfaces to traverse in a structure like a sequence.

8. The method of claim 1, wherein example implementations of interface queries connect an origin input & target output, which may be a problem & solution format, or may be a pair of components (like a pair of concepts) without a problem-solving intent function (like convert, differentiate, combine, inject, standardize, filter) given as part of the input, so a default problem-solving intent like ‘connect’ is applied, in which case the interface query checks for a connection (which can be formatted as solving a ‘find a connection function’ problem).

9. The method of claim 1, wherein example implementations of interface operations (like combine/apply interfaces for an intent like solving a particular problem) may include core interface operations like combine/apply/connect, as well as interface-specific logic of interactions between components on that interface.

10. A non-transitory computer-readable medium containing instructions that, when executed by a processor, cause a device to perform operations, the operations comprising:
definition routes
problem/solution structures
solution filter structures (like metrics, tests, conditions) to filter solution sets, or specify/adapt/refine/test solutions
insight paths (including solution automation workflows, which are insight paths that connect problem/solution formats)
functions to generate solution automation workflow insight paths
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’).

11. The non-transitory computer-readable medium of claim 10, wherein example implementations of definition routes of a component may format the component on various interfaces or in various formats that are useful for predicting that component's interactions/outputs, like change conditions & coordination with other components.

12. The non-transitory computer-readable medium of claim 10, wherein example implementations of problem/solution structures may make connecting functions trivial to find/generate/derive. Example implementations of problem/solution structures may be structurally similar in a way that is trivial to connect, such as:
randomness problem format & organization solution format
conflicting direction problem format & aligning re-routing solution format
reduction problem format & expansion/standardization solution format
lack problem format & generative efficiency solution format
identify problem format & uniqueness solution format.

13. The non-transitory computer-readable medium of claim 10, wherein example implementations of solution filter structures (like metrics, tests, conditions) can be used to filter solution sets or specify/adapt/refine/test a solution.

14. The non-transitory computer-readable medium of claim 10, wherein example implementations of insight paths can be used to identify relevant problem/solution structures (like connections between variables) & exclude relevant problem/solution structures more optimally.

15. The non-transitory computer-readable medium of claim 10, wherein example implementations of functions generating solution automation workflow insight paths (which connect problem/solution formats) may include permutations of structures of problem/solution components like variables/structures (such as formats, component/adjacent/proxy structures, origin/target position/state, connecting functions, definitions, workflows, attributes like complexity, etc).

16. The non-transitory computer-readable medium of claim 10, wherein example implementations of query-building logic may include logic to select an interface to traverse, selecting multiple interface queries to execute in parallel, & organizing interfaces to traverse in a structure like a sequence.

17. The non-transitory computer-readable medium of claim 10, wherein example implementations of interface queries connect an origin input & target output, which may be a problem & solution format, or may be a pair of components (like a pair of concepts) without a problem-solving intent function (like convert, differentiate, combine, inject, standardize, filter) given as part of the input, so a default problem-solving intent like ‘connect’ is applied, in which case the interface query checks for a connection (which can be formatted as solving a ‘find a connection function’ problem).

18. The non-transitory computer-readable medium of claim 10, wherein example implementations of interface operations (like combine/apply interfaces for an intent like solving a particular problem) may include core interface operations like combine/apply/connect, as well as interface-specific logic of interactions between components on that interface.

19. A system comprising: one or more processors; and one or more non-transitory computer-readable media containing instructions that, when executed by the one or more processors, cause the system to perform operations, the operations comprising:
definition routes
problem/solution structures
solution filter structures (like metrics, tests, conditions) to filter solution sets, or specify/adapt/refine/test solutions
insight paths (including solution automation workflows, which are insight paths that connect problem/solution formats)
functions to generate solution automation workflow insight paths
interface query-building logic (to generate interface queries)
interface queries (to complete a task by connecting the origin input & target output, which may be a problem & solution format)
interface operations (combine interfaces, apply the causal interface to a structure to solve a problem of ‘finding cause’, apply an interface to an interface), including interface-specific analysis logic (like connecting functions of components of that interface, such as the info interface function to ‘apply insight paths to solve a problem’).

20. The system of claim 19, wherein example implementations of definition routes of a component may format the component on various interfaces or in various formats that are useful for predicting that component's interactions/outputs, like change conditions & coordination with other components.

21. The system of claim 19, wherein example implementations of problem/solution structures may make connecting functions trivial to find/generate/derive. Example implementations of problem/solution structures may be structurally similar in a way that is trivial to connect, such as:
randomness problem format & organization solution format
conflicting direction problem format & aligning re-routing solution format
reduction problem format & expansion/standardization solution format
lack problem format & generative efficiency solution format
identify problem format & uniqueness solution format.

22. The system of claim 19, wherein example implementations of solution filter structures (like metrics, tests, conditions) can be used to filter solution sets or specify/adapt/refine/test a solution.

23. The system of claim 19, wherein example implementations of insight paths can be used to identify relevant problem/solution structures (like connections between variables) & exclude relevant problem/solution structures more optimally.

24. The system of claim 19, wherein example implementations of functions generating solution automation workflow insight paths (which connect problem/solution formats) may include permutations of structures of problem/solution components like variables/structures (such as formats, component/adjacent/proxy structures, origin/target position/state, connecting functions, definitions, workflows, attributes like complexity, etc).

25. The system of claim 19, wherein example implementations of query-building logic may include logic to select an interface to traverse, selecting multiple interface queries to execute in parallel, & organizing interfaces to traverse in a structure like a sequence.

26. The system of claim 19, wherein example implementations of interface queries connect an origin input & target output, which may be a problem & solution format, or may be a pair of components (like a pair of concepts) without a problem-solving intent function (like convert, differentiate, combine, inject, standardize, filter) given as part of the input, so a default problem-solving intent like ‘connect’ is applied, in which case the interface query checks for a connection (which can be formatted as solving a ‘find a connection function’ problem).

27. The system of claim 19, wherein example implementations of interface operations (like combine/apply interfaces for an intent like solving a particular problem) may include core interface operations like combine/apply/connect, as well as interface-specific logic of interactions between components on that interface.
